(19) United States
(12) Patent Application Publication
(10) Pub. No.: US 2003/0166414 A1
(43) Pub. Date: Sep. 4, 2003

(54) Contents data processing apparatus and method

(76) Inventors: Yoichiro Sako, Tokyo (JP); Mitsuru Toriyama, Chiba (JP); Tatsuya Inokuchi, Tokyo (JP); Yoshimasa Utsumi, Tokyo (JP); Kaoru Kijima, Tokyo (JP); Kazuko Sakurai, Tokyo (JP); Takashi Kihara, Chiba (JP); Shunsuke Furukawa, Tokyo (JP)

Correspondence Address: JAY H. MAIOLI, Cooper & Dunham LLP, 1185 Avenue of the Americas, New York, NY, 10036, US

(21) Appl. No.: 10/364,495

(22) Filed: Feb. 11, 2003

(30) Foreign Application Priority Data
Feb. 20, 2002 (JP) P2002-043660
Feb. 28, 2002 (JP) P2002-053502

(51) Int. Cl. G06F 17/00; A63F 13/00

(52) U.S. Cl. 463/30

(57) ABSTRACT

A contents data processing method comprises the steps of, at the time of processing contents data, reproducing character information changed with processing of the contents data, and selectively changing processing of the contents data in accordance with the reproduced character information.

### BACKGROUND OF THE INVENTION

1. Field of the Invention

The present invention relates to a contents data processing method and a contents data processing apparatus. More particularly, the present invention relates to a contents data processing method and a contents data processing apparatus in which contents data is processed using character information.

2. Description of the Related Art

Recently, character bringing-up games, in which users bring up virtual characters and enjoy the growing process of the characters, have been developed in various forms. For example, there are portable game machines in which users bring up characters displayed on a liquid crystal panel by repeating breeding operations such as feeding and exercising the characters, and application software for personal computers, which allows users to dialogue with characters to be brought up.

Japanese Laid Open Patent No. 11-231880, for example, discloses an information distributing system in which a character image displayed on an information terminal device is brought up depending on download history of music, e.g., karaoke songs, from an information distributing apparatus to the information terminal device.

The above-described portable game machines and application software lay main emphasis on bringing-up of characters so that users are interested in the process of bringing up characters. The above-described information distributing system increases entertainingness by adding a factor of growth of characters to playing of music.

However, as seen from the fact that a boom of the above-described portable game machines has been temporary, a period during which users become enthusiastic in “bringing-up characters” is not so long, and those games tend to lose popularity among users in a short period. Accordingly, a factor capable of keeping users from becoming weary soon is demanded in those games in addition to the factor of “bringing-up of characters”.

### SUMMARY OF THE INVENTION

It is therefore an object of the present invention to provide a contents data processing method which resolves the above-mentioned problem.

It is another object of the present invention to provide a contents data processing apparatus which resolves the above-mentioned problem.

According to the present invention, there is provided a contents data processing method. The processing method comprises the steps of, at the time of processing contents data, reproducing character information changed with processing of the contents data, and selectively changing processing of the contents data in accordance with the reproduced character information.

According to the present invention, there is provided a contents data processing apparatus including a storing unit, a reproducing unit, and a processing unit. The storing unit stores character information. The reproducing unit reproduces character information read out of the storing unit. The processing unit processes supplied contents data. The processing unit selectively changes processing of the contents data in accordance with the character information reproduced by the reproducing unit.

According to the present invention, there is provided a contents data processing apparatus including a reproducing unit and a processing unit. The reproducing unit reproduces character information associated with supplied storing unit. The processing unit processes the supplied contents data. The processing unit selectively changes processing of the contents data in accordance with the character information reproduced by the reproducing unit.

According to the present invention, there is provided a contents data processing apparatus including a creating unit and a processing unit. The creating unit creates character information from information associated with supplied contents data. The processing unit processes the supplied contents data. The processing unit selectively changes processing of the contents data in accordance with the character information created by the creating unit.

### BRIEF DESCRIPTION OF THE DRAWINGS

FIG. 1 is a schematic block diagram showing a first configuration example of a contents data processing apparatus according to a first embodiment of the present invention;

FIG. 2 is a flowchart for explaining one example of contents data processing executed in the contents data processing apparatus of FIG. 1;

FIG. 3 is a schematic block diagram showing a second configuration example of a contents data processing apparatus according to the first embodiment of the present invention;

FIG. 4 is a flowchart for explaining one example of contents data processing executed in the contents data processing apparatus of FIG. 3;

FIG. 5 is a flowchart for explaining one example of a billing process;

FIG. 6 is a schematic block diagram showing a first configuration example of a contents data processing apparatus according to a second embodiment of the present invention;

FIG. 7 is a flowchart for explaining one example of contents data processing executed in the contents data processing apparatus of FIG. 6;

FIG. 8 is a schematic block diagram showing a second configuration example of a contents data processing apparatus according to the second embodiment of the present invention;

FIG. 9 is a flowchart for explaining one example of contents data processing executed in the contents data processing apparatus of FIG. 8;

FIG. 10 is a schematic block diagram showing a third configuration example of a contents data processing apparatus according to the second embodiment of the present invention;

FIG. 11 is a flowchart for explaining one example of contents data processing executed in the contents data processing apparatus of FIG. 10;

FIG. 12 is a schematic block diagram showing a fourth configuration example of a contents data processing apparatus according to the second embodiment of the present invention;

FIG. 13 is a flowchart for explaining one example of contents data processing executed in the contents data processing apparatus of FIG. 12;

FIG. 14 is a schematic block diagram showing a fifth configuration example of a contents data processing apparatus according to the second embodiment of the present invention;

FIG. 15 is a flowchart for explaining one example of contents data processing executed in the contents data processing apparatus of FIG. 14;

FIG. 16 is a schematic block diagram showing a configuration of a contents data processing apparatus according to a third embodiment of the present invention;

FIG. 17 is a flowchart for explaining one example of contents data processing executed in the contents data processing apparatus of FIG. 16;

FIG. 18 is a flowchart for explaining one example of a step of creating character information in the flowchart of FIG. 17;

FIG. 19 is a schematic block diagram showing a configuration of a contents data processing apparatus according to a fourth embodiment of the present invention;

FIG. 20 is a flowchart for explaining one example of a process of reproducing contents data executed in the contents data processing apparatus of FIG. 19; and

FIG. 21 is a schematic block diagram showing a configuration of a contents data processing apparatus according to a fifth embodiment of the present invention.

### DESCRIPTION OF THE PREFERRED EMBODIMENTS

A first embodiment of the present invention will be described below.

A contents data processing apparatus according to the first embodiment has two configuration examples, which are explained in sequence in the following description.

(First Configuration Example)

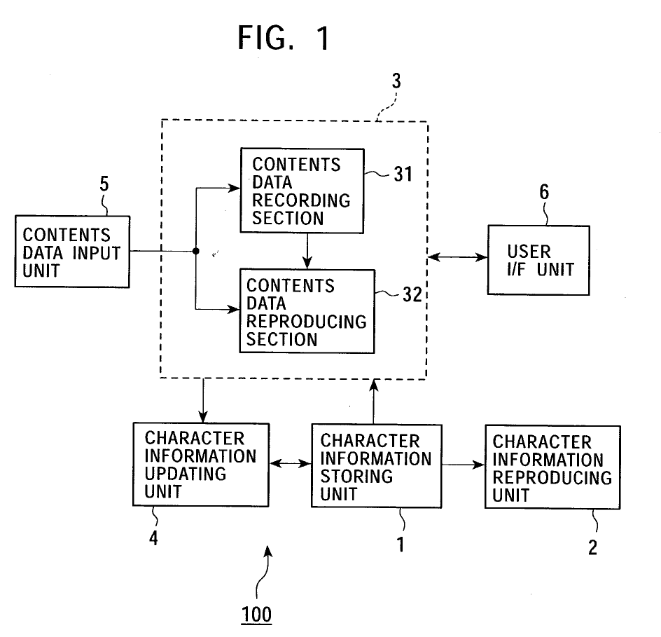

FIG. 1 is a schematic block diagram showing a first configuration example of the contents data processing apparatus according to the first embodiment of the present invention.

A contents data processing apparatus 100 shown in FIG. 1 comprises a character information storing unit 1, a character information reproducing unit 2, a processing unit 3, a character information updating unit 4, a contents data input unit 5, and a user interface (I/F) unit 6.

The character information storing unit 1 stores information regarding a character brought up with processing of contents data (hereinafter referred to simply as “character information”).

The character information contains, for example, information representing a temper, a growth process, and other nature of each character, specifically degrees of temper, growth, etc., in numerical values, and information indicating the types of characters, specifically the kinds of persons, animals, etc. In addition to such information indicating the nature and types of characters, information reproduced in the character information reproducing unit 2, described later, e.g., information of images and voices, is also stored in the character information storing unit 1.

The character information reproducing unit 2 reproduces information depending on the character information stored in the character information storing unit 1.

For example, the reproducing unit 2 reproduces, from among plural pieces of image and voice information stored in the character information storing unit 1 beforehand, information selected depending on the information indicating the nature and type of the character.

Depending on the information indicating the nature and type of the character, the reproducing unit 2 may additionally process the image and voice of the character. In other words, the reproducing unit 2 may additionally execute various processes such as changing the shape, hue, brightness and action of the character image, the loudness and tone of the character voice, and the number of characters.

When a contents data reproducing/output device, e.g., a display and a speaker, in the processing unit 3 is the same as a character information reproducing/output device, the character information reproducing unit 2 may execute a process of combining a reproduction result of the processing unit 3 and a reproduction result of the character information with each other.

The processing unit 3 executes predetermined processing designated by a user through the user interface unit 6 on contents data inputted from the contents data input unit 5. On this occasion, the quality of the processing executed by the processing unit 3 is changed depending on the character information stored in the character information storing unit 1.

For example, in a configuration in which the processing unit 3 comprises a contents data recording section 31 and a contents data reproducing section 32, as shown in FIG. 1, the quality in recording and reproducing the contents data is changed depending on the character information.

The contents data recording section 31 includes a storage device using a storage medium, such as a hard disk or a semiconductor memory, and records contents data inputted from the contents data input unit 5 in the storage device with the quality depending on the character information.

Incidentally, the contents data recording section 31 may not include a storage device therein. In this case, the inputted contents data may be recorded in a storage device accessible via a wireless or wired communication line.

The quality in recording of the contents data to be changed in the processing unit 3 depending on the character information contains, for example, image quality of image data included in the contents data, sound quality of voice data therein, the number of voice channels (stereo/monaural, etc.), a data compression method and rate, etc.

The effective number of times and the effective period, at and during which the contents data recorded in the processing unit 3 is reproducible, may be set and changed depending on the character information. In this case, the contents data having exceeded the set effective number of times or the set effective period is erased or made unreadable.

More simply, the processing unit 3 may just permit or prohibit the recording of the contents data depending on the character information.

The contents data reproducing section 32 includes, for example, an image reproducing device, such as a display, for reproducing image information, and a voice reproducing device, such as a speaker, for reproducing voice information. The contents data reproducing section 32 reproduces image information and voice information, which are contained in the contents data inputted from the contents data input unit 5 or the contents data read out of the contents data recording section 31, with the quality depending on the character information.

Incidentally, the contents data reproducing section 32 may include neither image reproducing device nor voice reproducing device. In this case, reproduced image and voice information may be outputted to the user interface unit 6 or any other suitable device so as to reproduce the contents data in the device at the output destination.

As with the recording quality mentioned above, the quality in reproducing the contents data to be changed in the processing unit 3 depending on the character information contains, for example, image quality, sound quality, the number of voice channels, a data compression method and rate, etc.

The effective number of times and the effective period, at and during which the contents data recorded in the contents data recording section 31 of the processing unit 3 is reproducible, may be set and changed depending on the character information. In this case, the contents data having exceeded the set effective number of times or the set effective period is erased or made unreadable.

More simply, the processing unit 3 may just permit or prohibit the reproduction of the contents data depending on the character information.

Further, when there is contents data additionally supplemented with main contents data (hereinafter referred to as “supplemental contents data”), the processing unit 3 may change the processing executed on the supplemental contents data depending on the character information. In the configuration example of FIG. 1, for example, the processing unit 3 permits or prohibits the process of recording the supplemental contents data in the contents data recording section 31 and the process of reproducing the supplemental contents data in the contents data reproducing section 32, or changes the quality in recording and reproduction of the supplemental contents data depending on the character information.

Examples of the supplemental contents data include words information, jacket photographs, profile information of artists, and liner notes, which are added to music contents data. The supplemental contents data may be a coupon including various bonuses.

The character information updating unit 4 updates the character information stored in the character information storing unit 1 depending on the run status of the processing executed in the processing unit 3.

For example, the character information updating unit 4 updates the information regarding the nature and type of the character by increasing the degree of growth of the character whenever the contents data is recorded or reproduced, and by reducing the degree of growth of the character when the contents data is neither recorded nor reproduced.

The contents data input unit 5 is a block for inputting contents data to the processing unit 3, and may comprise any suitable one of various devices, such as an information reader for reading contents data recorded on a storage medium, e.g., a memory card and a magneto-optic disk, and a communication device for accessing a device in which contents data is held, and then downloading the contents data.

The user interface unit 6 transmits, to the processing unit 3, an instruction given from the user through a predetermined operation performed by the user using a switch, a button, a mouse, a keyboard, a microphone, etc. A display, a lamp, a speaker, etc. may also be used to output the processing result of the processing unit 3 to the user.

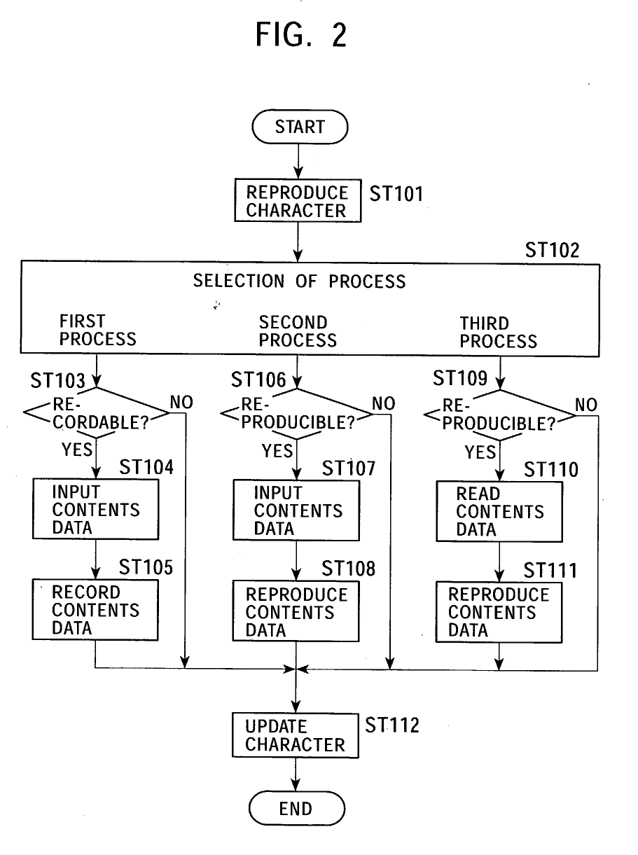

One example of contents data processing executed in the contents data processing apparatus 100 of FIG. 1 will be described below with reference to a flowchart of FIG. 2.

First, the character information stored in the character information storing unit 1 is reproduced in the character information reproducing unit 2 for displaying the progress in bringing-up of the character information to the user (step ST101). The processing unit 3 prompts the user to select a process through the user interface unit 6, and the user selects one of first to third processes (step ST102). The selection result is inputted from the user interface unit 6 to the processing unit 3.

First Process:

In a first process, a process of recording contents data inputted from the contents data input unit 5 in the contents data recording section 31 is executed.

Based on the character information currently stored in the character information storing unit 1, it is determined whether recording of the contents data is permitted (step ST103). If the recording is permitted, the contents data is inputted from the contents data input unit 5 to the processing unit 3 (step ST104), and then recorded in the contents data recording section 31 (step ST105). At this time, the quality in recording the contents data is set depending on the character information. For example, recording of supplemental contents data, such as words information, is permitted or prohibited in accordance with the character information, and the quality in recording the supplemental contents data is set depending on the character information.

On the other hand, if it is determined based on the current character information that the recording of the contents data is not permitted, the process of inputting the contents data (step ST104) and the process of recording the contents data (step ST105) are skipped.

Second Process:

In a second process, a process of reproducing contents data inputted from the contents data input unit 5 in the contents data reproducing section 32 is executed.

Based on the current character information, it is determined whether reproduction of the contents data inputted from the contents data input unit 5 is permitted (step ST106). If the reproduction is permitted, the contents data is inputted from the contents data input unit 5 to the processing unit 3 (step ST107), and then reproduced in the contents data reproducing section 32 (step ST108). At this time, the quality in reproducing the contents data is set depending on the character information. For example, reproduction of supplemental contents data is permitted or prohibited in accordance with the character information, and the quality in reproducing the supplemental contents data is set depending on the character information.

On the other hand, if it is determined in step ST106 based on the current character information that the reproduction of the contents data is not permitted, the process of inputting the contents data (step ST107) and the process of reproducing the contents data (step ST108) are skipped.

Third Process:

In a third process, a process of reading the contents data recorded in the contents data recording section 31 and reproducing it in the contents data reproducing section 32 is executed.

Based on the current character information, it is determined whether reproduction of the contents data recorded in the contents data recording section 31 is permitted (step ST109). If the reproduction is permitted, desired contents data is read out of the contents data recording section 31 (step ST110), and then reproduced in the contents data reproducing section 32 (step ST111). At this time, the quality in reproducing the contents data is set depending on the character information. For example, reproduction of supplemental contents data is permitted or prohibited in accordance with the character information, and the quality in reproducing the supplemental contents data is set depending on the character information.

On the other hand, if it is determined in step ST109 based on the current character information that the reproduction of the contents data is not permitted, the process of inputting the contents data (step ST110) and the process of reproducing the contents data (step ST111) are skipped.

After the execution of the above-described first to third processes, the character information stored in the character information storing unit 1 is updated depending on the run status of the processing executed on the contents data (step ST112). For example, the character information is updated depending on the total number of times of runs of the contents data processing and the frequency of runs of the contents data processing during a certain period.

Thus, as the processing of the contents data is repeated many times, the character information is updated depending on the run status of the contents data processing, and the form of the character reproduced in the character information reproducing unit 2 is gradually changed.

Responsive to the change of the character, details of the contents data processing executed in the processing unit 3 are also changed. For example, the process of recording the contents data, which has been disabled for the character in the initial state, becomes enabled with repeated reproduction of the contents data. As another example, the quality in reproducing the contents data is improved depending on the degree of growth of the character, or the reproduction of supplemental contents data is newly permitted.

With the contents data processing apparatus 100 of FIG. 1, therefore, since the fun of the character bringing-up game is added to the fun with ordinary processing of contents data, increased amusingness can be given to users in processing the contents data.

Users can enjoy not only the growth of a character, but also changes in processing of the contents data with the growth of the character. This keeps from the users from becoming weary soon unlike the character bringing-up game in which main emphasis is put on the growth of a character. For example, as the contents data is reproduced many times, users can enjoy the progress of growth of the character form. Further, users can feel satisfaction with an improvement in processing quality of the contents data, such as gradually improved image and sound quality of the reproduced contents data, a change from monaural to stereo sounds, or release from prohibition of copying of the contents data. Thus, since the fun in processing the contents data is combined with the fun of the character bringing-up game, it is possible to give the users increased amusingness as a result of the synergistic effect.

(Second Configuration Example)

A second configuration example of a contents data processing apparatus according to the first embodiment will be described below.

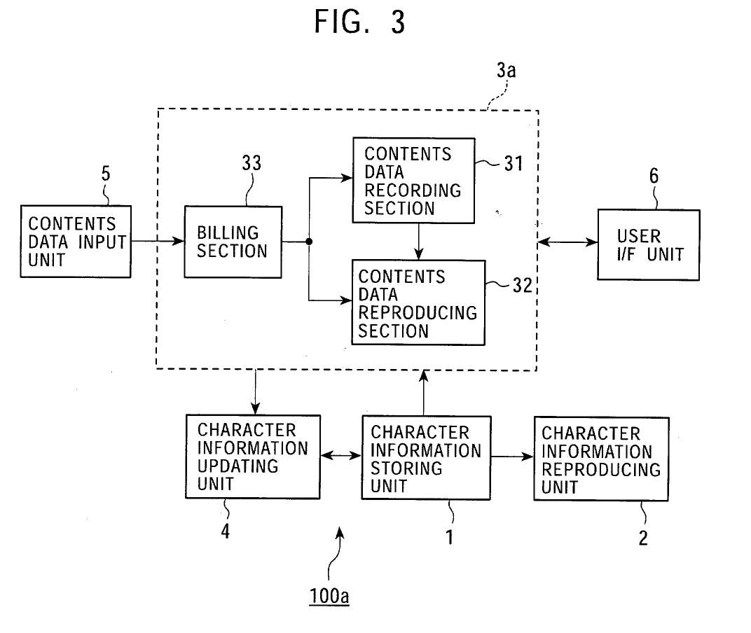

FIG. 3 is a schematic block diagram showing the second configuration example of the contents data processing apparatus according to the first embodiment.

A contents data processing apparatus 100a shown in FIG. 3 comprises a character information storing unit 1, a character information reproducing unit 2, a processing unit 3a, a character information updating unit 4, a contents data input unit 5, and a user interface (I/F) unit 6. Note that components in FIG. 3 common to those in FIG. 1 are denoted by the same reference symbols, and a detailed description of those components is omitted here.

As with the processing unit 3 in FIG. 1, the processing unit 3a executes predetermined processing designated by a user through the user interface unit 6 on contents data inputted from the contents data input unit 5, and changes the quality in processing of the contents data depending on the character information stored in the character information storing unit 1.

When the inputted contents data is charged data, the processing unit 3a limits the processing of the charged contents data. For example, the processing unit 3a disables the processing of the charged contents data or limits details of the processing in comparison with the ordinary processing. When the contents data is encrypted, the processing unit 3a stops a decrypting process to disable the processing of the encrypted contents data.

The above-described limitation on the processing of the charged contents data is released upon predetermined payment information being inputted from the user interface unit 6. More specifically, when predetermined payment information is inputted from the user interface unit 6, the processing unit 3a checks whether the inputted payment information satisfies a predetermined payment condition. If the predetermined payment condition is satisfied, the above-described limitation on the processing of the charged contents data is released so that the content data processing in response to a user's processing request inputted from the user interface unit 6 can be executed. For example, the processing unit 3a decrypts the encrypted charged contents data, thereby enabling the charged contents data to be processed.

The payment condition used in the step of checking the payment information by the processing unit 3a is changed depending on the character information stored in the character information storing unit 1. In other words, the payment condition becomes more severe or moderate depending on the growth of a character.

The charge of the contents data may be changed depending on information regarding the total purchase charge of the contents data or information regarding the number of times of purchases of the contents data, which is contained in the character information.

The processing unit 3a comprises, as shown in FIG. 3, a billing section 33 in addition to a contents data recording section 31 and a contents data reproducing section 32.

The billing section 33 determines whether the contents data inputted from the contents data input unit 5 is charged data, and then displays the determination result on the user interface unit 6. When predetermined payment information corresponding to the display is inputted from the user interface unit 6, the billing section 33 checks whether the inputted payment information satisfies a predetermined payment condition. If the inputted payment information satisfies the predetermined payment condition, the billing section 33 releases the limitation on processing of the charged contents data so that the charged contents data can be processed in the contents data recording section 31 and the contents data reproducing section 32. If the inputted payment information does not satisfy the predetermined payment condition, the billing section 33 limits the processing of the charged contents data.

For example, the billing section 33 prompts the user to input cash or any other equivalent (such as a prepaid card) through the user interface unit 6, and then checks whether the inputted cash or the like is genuine and whether the amount of money is proper. In accordance with the check result, the billing section 33 enables the processes of recording and reproducing the contents data to be executed.

Alternatively, the billing section 33 may prompt the user to input the user's credit card number or ID information through the user interface unit 6, and then refer to an authentication server or the like about whether the inputted information is proper. In accordance with the authentication result, the billing section 33 may permit the processes of recording and reproducing the contents data to be executed.

One example of contents data processing executed in the contents data processing apparatus 100a of FIG. 3 will be described below.

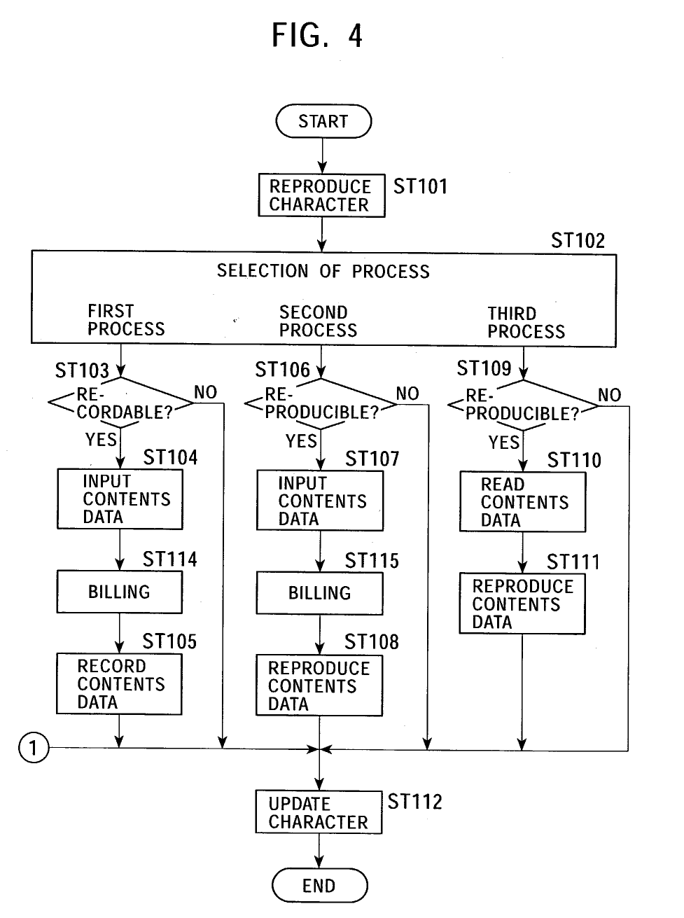

FIG. 4 is a flowchart for explaining one example of the contents data processing executed in the above-described contents data processing apparatus 100a of FIG. 3. In FIG. 4, the same symbols as those in FIG. 2 denote steps in each of which similar processing is executed as in FIG. 2.

As seen from comparing FIGS. 4 and 2, a flowchart of FIG. 4 differs from the flowchart of FIG. 2 in that billing processes (step ST114 and step ST115) are inserted respectively between steps ST104 and ST105 and between steps ST107 and ST108.

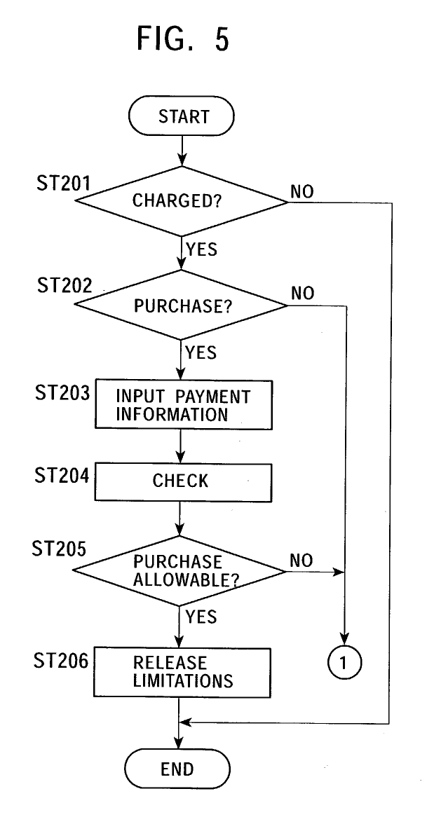

FIG. 5 is a flowchart for explaining one example of the billing process.

According to the flowchart of FIG. 5, the billing section 33 first determines whether the contents data inputted from the contents data input unit 5 is charged data (step S201). If the inputted contents data is free, the subsequent billing process is skipped.

If the inputted contents data is charged data, whether to purchase the contents data or not is selected based on user's judgment inputted from the user interface unit 6 (step ST202). If the purchase of the contents data is selected in step ST202, predetermined payment information is inputted from the user interface unit 6 (step ST203). Then, the billing section 33 checks whether the inputted payment information satisfies a predetermined payment condition (step ST204).

The payment condition used in the above step is set depending on the character information stored in the character information storing unit 1. The payment condition becomes more severe or moderate depending on, for example, the growth of a character.

In accordance with the result of checking the payment information in step ST204, whether to release the limitation on processing of the contents data or not is selected (step ST205). If the release of the limitation is selected, the billing section 33 releases the limitation on processing of the contents data (step ST206). For example, a process of decrypting the encrypted contents data is executed.

If the user does not select the purchase of the contents data in step ST202, or if the release of the limitation on processing of the contents data is rejected in step ST205, the step of releasing the limitation on processing of the contents data (step ST206) and the subsequent steps of processing the contents data (steps ST105 and ST108) are both skipped. The process flow shifts to a step of updating the character (step ST112).

The above-described contents data processing apparatus 100a of FIG. 3 can provide similar advantages as those in the contents data processing apparatus 100 of FIG. 1. In addition, since the payment condition in purchasing the charged contents data is changed depending on the character information, the fun in processing the contents data is further increased and users can feel even higher amusingness.

A second embodiment of the present invention will be described below.

In each of the above-described contents data processing apparatuses of FIGS. 1 and 3, the character information is stored in the contents data processing apparatus, i.e., information associated with the contents data processing apparatus. On the other hand, in the second embodiment described below, the character information is associated with the contents data. Therefore, even when, for example, the same contents data is processed by the same contents data processing apparatus, different characters are reproduced if the character information associated with one content data differs from that associated with another content data.

A contents data processing apparatus according to the second embodiment has five configuration examples, which are explained in sequence in the following description.

(First Configuration Example)

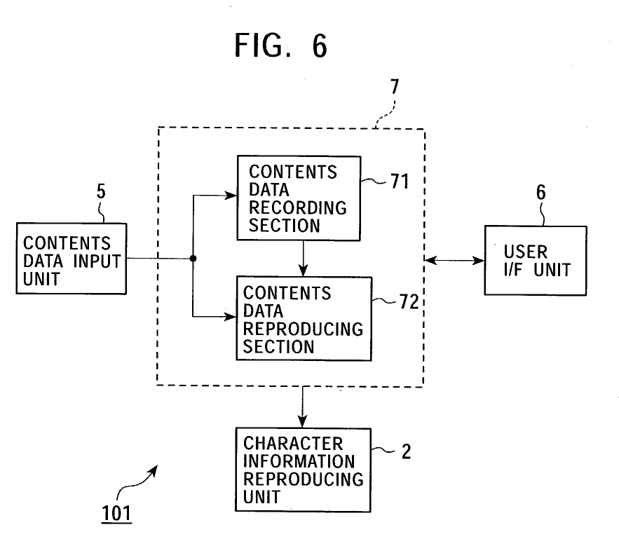

FIG. 6 is a schematic block diagram showing a first configuration example of the contents data processing apparatus according to the second embodiment of the present invention.

A contents data processing apparatus 101 shown in FIG. 6 comprises a character information reproducing unit 2, a contents data input unit 5, a user interface (I/F) unit 6 and a processing unit 7. Note that, in FIG. 6, the same symbols as those in FIG. 1 denote the same components as those in FIG. 1.

The processing unit 7 executes predetermined processing designated by a user through the user interface unit 6 on contents data inputted from the contents data input unit 5. On this occasion, the quality of the processing executed by the processing unit 7 is changed depending on the character information associated with the inputted contents data.

For example, in a configuration in which the processing unit 7 comprises a contents data recording section 71 and a contents data reproducing section 72, as shown in FIG. 6, the equality in recording and reproducing the contents data is changed depending on the character information associated with the contents data.

The contents data recording section 71 includes a storage device using a storage medium, such as a hard disk or a semiconductor memory, and records contents data inputted from the contents data input unit 5 in the storage device with the quality depending on the associated character information. At the same time as recording the contents data, the associated character information is also recorded together.

Incidentally, the contents data recording section 71 may not include a storage device therein. In this case, the inputted contents data and character information may be recorded in a storage device accessible via a wireless or wired communication line.

As with the contents data recording section 31 shown in FIG. 1, the quality in recording of the contents data to be changed in the processing unit 7 depending on the character information contains, for example, image quality of image data included in the contents data, sound quality of voice data therein, the number of voice channels, a data compression method and rate, etc.

The effective period, during which the contents data recorded in the processing unit 7 is reproducible, may be set and changed depending on the character information.

More simply, the processing unit 7 may just permit or prohibit the recording of the contents data depending on the character information.

The contents data reproducing section 72 includes, for example, an image reproducing device, such as a display, for reproducing image information, and a voice reproducing device, such as a speaker, for reproducing voice information. The contents data reproducing section 72 reproduces image information and voice information, which are contained in the contents data inputted from the contents data input unit 5 or in the contents data read out of the contents data recording section 71, with the quality depending on the character information associated with the contents data.

Incidentally, the contents data reproducing section 72 may include neither image reproducing device nor voice reproducing device. In this case, reproduced image and voice information may be outputted to the user interface unit 6 or any other suitable device so as to reproduce the contents data in the device at the output destination.

As with the recording quality mentioned above, the quality in reproduction of the contents data to be changed in the processing unit 7 depending on the character information contains, for example, image quality, sound quality, the number of voice channels, a data compression method and rate, etc.

The effective number of times and the effective period, at and during which the contents data recorded in the contents data recording section 71 of the processing unit 7 is reproducible, may be set and changed depending on the character information.

More simply, the processing unit 7 may just permit or prohibit the reproduction of the contents data depending on the character information.

Further, when there is contents data additionally supplemented with main contents data (hereinafter referred to as “supplemental contents data”), the processing unit 7 may change the processing executed on the supplemental contents data depending on the character information associated with the contents data. In the configuration example of FIG. 6, for example, the processing unit 7 permits or prohibits the process of recording the supplemental contents data in the contents data recording section 71 and the process of reproducing the supplemental contents data in the contents data reproducing section 72, or changes the quality in recording and reproduction of the supplemental contents data depending on the character information associated with the contents data.

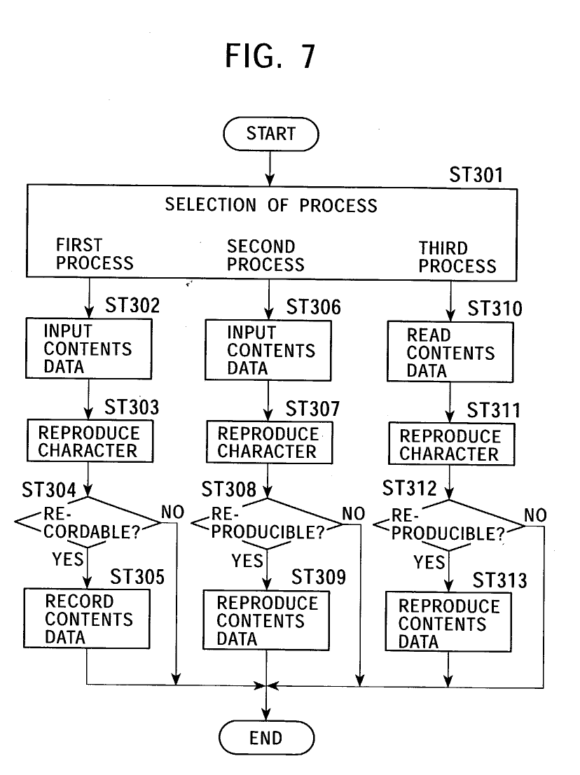

One example of contents data processing executed in the contents data processing apparatus 101 of FIG. 6 will be described below with reference to a flowchart of FIG. 7.

First, the processing unit 7 prompts the user to select a process through user interface unit 6. Then, the user selects one of first to third processes and the selection result is inputted from the user interface unit 6 to the processing unit 7 (step ST301).

First Process:

In a first process, a process of recording contents data inputted from the contents data input unit 5 in the contents data recording section 71 is executed.

First, contents data is inputted from the contents data input unit 5 (step ST302), and character information associated with the inputted contents data is reproduced in the character information reproducing unit 2 (step ST303).

Then, based on the character information associated with the inputted contents data, it is determined whether recording of the contents data is permitted (step ST304). If the recording is permitted, the inputted contents data is recorded in the contents data recording section 71 (step ST305). At this time, the quality in recording the contents data is set depending on the character information. For example, recording of supplemental contents data, such as words information, is permitted or prohibited in accordance with the character information, and the quality in recording the supplemental contents data is set depending on the character information.

On the other hand, if it is determined in step ST304 based on the character information associated with the inputted contents data that the recording of the contents data is not permitted, the process of recording the contents data (step ST305) is skipped.

Second Process:

In a second process, a process of reproducing contents data inputted from the contents data input unit 5 in the contents data reproducing section 72 is executed.

First, contents data is inputted from the contents data input unit 5 (step ST306), and character information associated with the inputted contents data is reproduced in the character information reproducing unit 2 (step ST307).

Then, based on the character information associated with the inputted contents data, it is determined whether reproduction of the contents data is permitted (step ST308). If the reproduction is permitted, the inputted contents data is reproduced in the contents data reproducing section 72 (step ST309). At this time, the quality in reproducing the contents data is set depending on the character information. For example, reproduction of supplemental contents data is permitted or prohibited in accordance with the character information, and the quality in reproducing the supplemental contents data is set depending on the character information.

On the other hand, if it is determined in step ST308 based on the character information associated with the inputted contents data that the reproduction of the contents data is not permitted, the process of reproducing the contents data (step ST309) is skipped.

Third Process:

In a third process, a process of reading the contents data recorded in the contents data recording section 71 and reproducing it in the contents data reproducing section 72 is executed.

First, desired contents data is read out of the contents data recording section 71 (step ST310), and character information associated with the read-out contents data is reproduced (step ST311).

Then, based on the character information associated with the contents data, it is determined whether reproduction of the contents data is permitted (step ST312). If the reproduction is permitted, the read-out contents data is reproduced in the contents data reproducing section 72 (step ST313). At this time, the quality in reproducing the contents data is set depending on the character information. For example, reproduction of supplemental contents data is permitted or prohibited in accordance with the character information, and the quality in reproducing the supplemental contents data is set depending on the character information.

On the other hand, if it is determined in step ST312 based on the character information associated with the read-out contents data that the reproduction of the contents data is not permitted, the process of reproducing the contents data (step,ST313) is skipped.

In the contents data processing described above, it is premised that the character information associated with the contents data is updated in the stage before the character information is supplied to the contents data processing apparatus 101, and the character information is not changed inside the contents data processing apparatus 101.

For example, each time contents data is downloaded from a contents data supply apparatus (not shown) to the contents data processing apparatus 101, character information associated with the downloaded contents data is updated in the contents data supply apparatus. By updating the character information for each download made by different users, it is possible to bring up a character changing in linkage with popularity of the contents data.

As an alternative example, character information depending on the result of another character bringing-up game, which has been played by a user, is associated with contents data when the user downloads the contents data from the contents data supply apparatus.

With the contents data processing apparatus 101 of FIG. 6, therefore, since the fun of the character bringing-up game is added to the fun with ordinary processing of contents data, increased amusingness can be given to users in processing the contents data as with the contents data processing apparatuses of FIGS. 1 and 3. Thus, since users can enjoy not only the growth of a character, but also changes in processing of the contents data with the growth of the character, it is possible to give the users increased amusingness.

(Second Configuration Example)

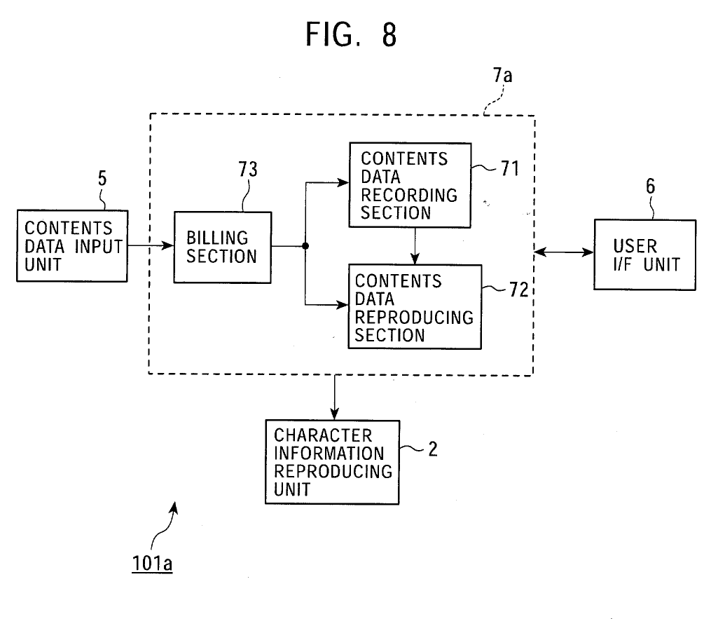

FIG. 8 is a schematic block diagram showing a second configuration example of a contents data processing apparatus according to the second embodiment.

A contents data processing apparatus 101a shown in FIG. 8 comprises a character information reproducing unit 2, a contents data input unit 5, a user interface (I/F) unit 6, and a processing unit 7a. Note that, in FIG. 8, the same symbols as those in FIG. 6 denote the same components as those in FIG. 6.

As with the processing unit 7 shown in FIG. 6, the processing unit 7a executes predetermined processing designated by a user through the user interface unit 6 on contents data inputted from the contents data input unit 5, and changes the quality in processing of the contents data depending on the character information associated with the inputted contents data.

When the inputted contents data is charged data, the processing unit 7a limits the processing of the charged contents data. For example, the processing unit 7a disables the processing of the charged contents data or limits details of the processing in comparison with the ordinary processing. When the contents data is encrypted, the processing unit 7a stops a decrypting process to disable the processing of the encrypted contents data.

The above-described limitation on the processing of the charged contents data is released upon predetermined payment information being inputted from the user interface unit 6. More specifically, when predetermined payment information is inputted from the user interface unit 6, the processing unit 7a checks whether the inputted payment information satisfies a predetermined payment condition. If the predetermined payment condition is satisfied, the above-described limitation on the processing of the charged contents data is released so that the content data processing in response to a user's processing request inputted from the user interface unit 6 can be executed. For example, the processing unit 7a decrypts the encrypted charged contents data, thereby enabling the charged contents data to be processed.

The payment condition used in the step of checking the payment information by the processing unit 7a is changed depending on the character information associated with the content data. In other words, the payment condition becomes more severe or moderate depending on the growth of a character associated with the content data.

The processing unit 7a comprises, as shown in FIG. 8, a billing section 73 in addition to a contents data recording section 71 and a contents data reproducing section 72.

The billing section 73 has the same function as the billing section 33, shown in FIG. 3, except for that the payment condition for the charged content data is changed depending on the character information associated with the charged content data.

More specifically, the billing section 73 determines whether the contents data inputted from the contents data input unit 5 is charged data, and then displays the determination result on the user interface unit 6. When predetermined payment information corresponding to the display is inputted from the user interface unit 6, the billing section 73 checks whether the inputted payment information satisfies a predetermined payment condition. If the inputted payment information satisfies the predetermined payment condition, the billing section 73 releases the limitation on processing of the charged contents data so that the charged contents data can be processed in the contents data recording section 71 and the contents data reproducing section 72. If the inputted payment information does not satisfy the predetermined payment condition, the billing section 73 limits the processing of the charged contents data.

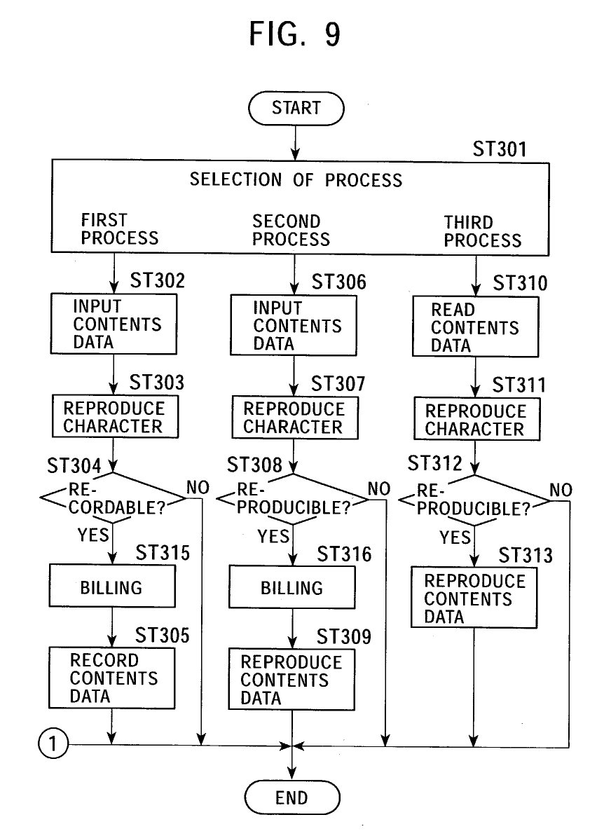

FIG. 9 is a flowchart for explaining one example of the contents data processing executed in the above-described contents data processing apparatus 101a of FIG. 8. In FIG. 9, the same symbols as those in FIG. 7 denote steps in each of which similar processing is executed as in FIG. 7.

As seen from comparing FIGS. 9 and 7, a flowchart of FIG. 9 differs from the flowchart of FIG. 7 in that billing processes (step ST315 and step ST316) are inserted respectively between steps ST304 and ST305 and between steps ST308 and ST309.

Each of those billing processes is substantially the same as the above-described process executed in accordance with the flowchart of FIG. 5 except for that the payment condition as a basis for checking the payment information in step ST204 is changed depending on the character information associated with the contents data.

Thus, the above-described contents data processing apparatus 101a of FIG. 8 can provide similar advantages as those in the contents data processing apparatus 101 of FIG. 6. In addition, since the payment condition in purchasing the charged contents data is changed depending on the character information, the fun in processing the contents data is further increased and users can feel even higher amusingness.

(Third Configuration Example)

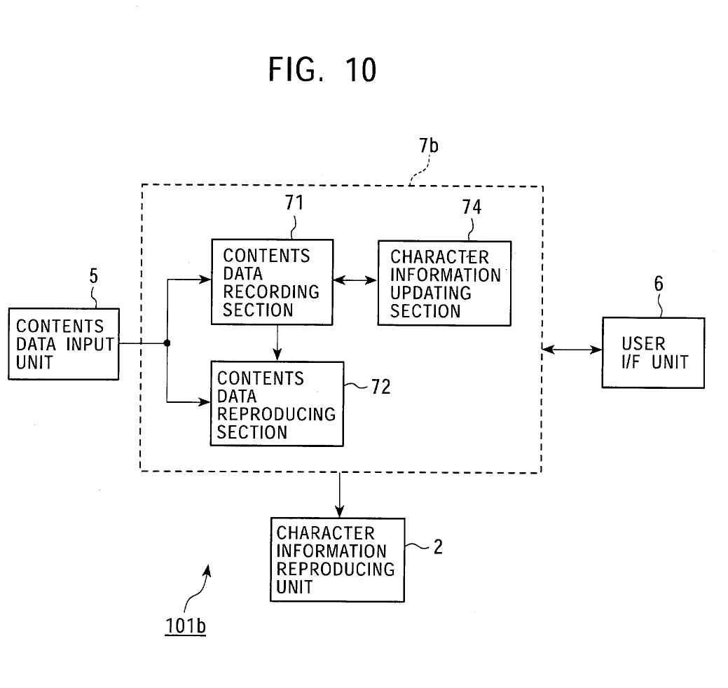

FIG. 10 is a schematic block diagram showing a third configuration example of a contents data processing apparatus according to the second embodiment.

A contents data processing apparatus 101b shown in FIG. 10 comprises a character information reproducing unit 2, a contents data input unit 5, a user interface (I/F) unit 6, and a processing unit 7b. Note that, in FIG. 10, the same symbols as those in FIG. 6 denote the same components as those in FIG. 6.

As with the processing unit 7 shown in FIG. 6, the processing unit 7b executes predetermined processing designated by a user through the user interface unit 6 on contents data inputted from the contents data input unit 5, and changes the quality in processing of the contents data depending on the character information associated with the inputted contents data.

The processing unit 7b updates the character information associated with the contents data, which is to be processed, depending on the run status of the processing executed on the contents data. The character information updated by the processing unit 7b is recorded in a contents data recording section 71 in association with the contents data.

The processing unit 7b comprises, as shown in FIG. 10, a character information updating section 74 in addition to a contents data recording section 71 and a contents data reproducing section 72.

In a process of recording the contents data inputted from the contents data input unit 5 in the contents data recording section 71 (i.e., first process) and in a process of reading and reproducing the contents data, which is recorded in the contents data recording section 71, in the contents data reproducing section 72 (i.e., third process), the character information updating section 74 updates the character information associated with the contents data, which is to be processed, depending on the run status of the first to third processes and then records the updated character information in the contents data recording section 71. For example, the updating unit 74 increases the degree of growth of the character depending on the total number of times of runs of those processes, or reduces the degree of growth of the character if the frequency of runs of those processes during a certain period exceeds below a certain level.

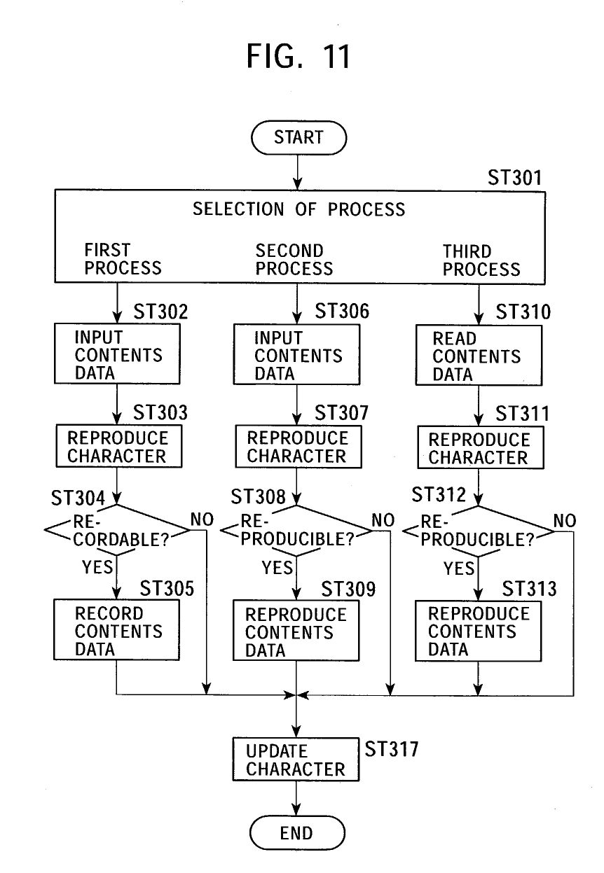

FIG. 11 is a flowchart for explaining one example of the contents data processing executed in the above-described contents data processing apparatus 101b of FIG. 10. In FIG. 11, the same symbols as those in FIG. 7 denote steps in each of which similar processing is executed as in FIG. 7.

As seen from comparing FIGS. 11 and 7, a flowchart of FIG. 11 differs from the flowchart of FIG. 7 in that a process of updating the character (step ST317) is inserted after the first to third processes.

More specifically, after run of one the first to third processes, the character information associated with the contents data, which is to be processed, is updated in step ST317 depending on the run status of the processing executed on the contents data, and the updated character information is recorded in the contents data recording section 71 in association with the contents data.

In the case of reproducing the inputted contents data in the second process, however, the processes of updating and recording the character information are not executed because the process of recording the inputted contents data is not executed.

Thus, as the processing of the contents data is repeated many times, the character information associated with the contents data is updated depending on the run status of the contents data processing, and the form of the character reproduced in the character information reproducing section 72 is gradually changed.

Responsive to the change of the character, details of the contents data processing executed in the processing unit 7b are also changed. For example, the process of recording the contents data, which has been disabled for the character in the initial state, becomes enabled with repeated reproduction of the contents data. As another example, the quality in reproducing the contents data is improved depending on the degree of growth of the character, or the reproduction of supplemental contents data is newly permitted.

With the contents data processing apparatus 101b of FIG. 10, therefore, since the fun of the character bringing-up game is added to the fun with ordinary processing of contents data, increased amusingness can be given to users in processing the contents data.

Since users can enjoy not only the growth of a character, but also changes in processing of the contents data with the growth of the character, it is possible to give the users further increased amusingness.

(Fourth Configuration Example)

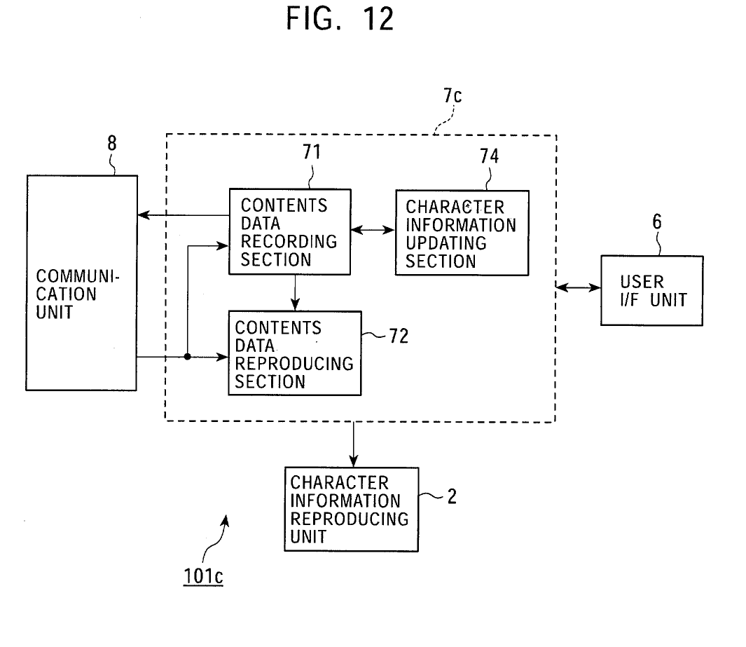

FIG. 12 is a schematic block diagram showing a fourth configuration example of a contents data processing apparatus according to the second embodiment.

A contents data processing apparatus 101c shown in FIG. 12 comprises a character information reproducing unit 2, a user interface (I/F) unit 6, a processing unit 7c, and a communication unit 8. Note that, in FIG. 12, the same symbols as those in FIG. 10 denote the same components as those in FIG. 10.

The processing unit 7c has basically similar functions to those of the processing unit 7b shown in FIG. 10. More specifically, the processing unit 7c executes predetermined processing designated by a user through the user interface unit 6 on contents data received by the communication unit 8, and changes the quality in processing of the contents data depending on the character information associated with the received contents data. The processing unit 7c updates the character information associated with the contents data, which is to be processed, depending on the run status of the processing executed on the contents data, and records the updated character information in association with the contents data.

Further, the processing unit 7c executes a process of selecting desired one of the contents data recorded in a contents data recording section 71 in response to a user's instruction entered from the user interface unit 6, and a process of transmitting, via the communication unit 8 (described below), the selected contents data to other contents data processing apparatuses or a contents data supply server for supplying contents data to those contents data processing apparatuses.

The communication unit 8 executes a process of exchanging contents data and character information with other contents data processing apparatuses or a contents data supply server for supplying contents data to those contents data processing apparatuses. Any suitable communication method can be employed in the communication unit 8. For example, wireless or wired communication is usable as required. Alternatively, the communication may be performed via a network such as the Internet.

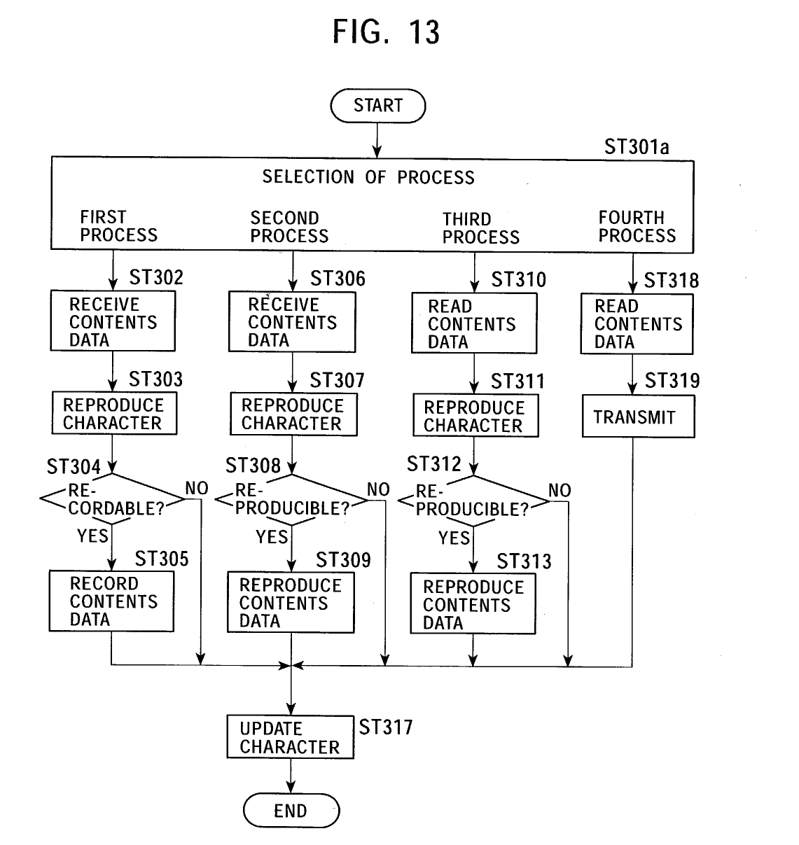

FIG. 13 is a flowchart for explaining one example of the contents data processing executed in the above-described contents data processing apparatus 101c of FIG. 12. In FIG. 13, the same symbols as those in FIG. 11 denote steps in each of which similar processing is executed as in FIG. 11.

As seen from comparing FIGS. 13 and 11, a flowchart of FIG. 13 differs from the flowchart of FIG. 11 in that a fourth process is added in a step of selecting a process (step ST301a).

More specifically, if the fourth process is selected in step ST301a in response to a user's instruction entered from the user interface unit 6, desired contents data corresponding to the user's instruction is read out of the contents data recorded in the contents data recording section 71 (step ST318). The read-out contents data is transmitted from the communication unit 8 to other contents data processing apparatuses or the contents data supply server (step ST319). Then, as with the first to third processes, a process of updating the character is executed in step ST317.

Thus, the above-described contents data processing apparatus 101c of FIG. 12 can provide similar advantages as those in the contents data processing apparatus 101b of FIG. 10. In addition, the contents data processing apparatus 101c can exchange or share contents data with the other contents data processing apparatuses or the contents data supply server. Therefore, since a user can bring up a character in cooperation with other users or exchange a character with other users, it is possible to give the user further increased amusingness.

(Fifth Configuration Example)

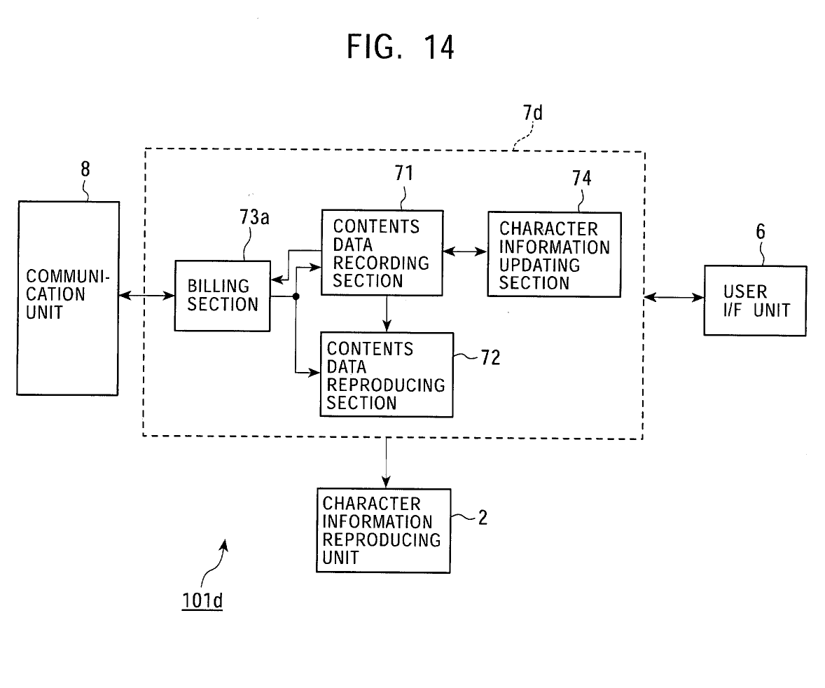

FIG. 14 is a schematic block diagram showing a fifth configuration example of a contents data processing apparatus according to the second embodiment.

A contents data processing apparatus 101d shown in FIG. 14 comprises a character information reproducing unit 2, a user interface (I/F) unit 6, a processing unit 7d, and a communication unit 8. Note that, in FIG. 14, the same symbols as those in FIG. 12 denote the same components as those in FIG. 12.

The processing unit 7d has basically similar functions to those of the processing unit 7c shown in FIG. 12. More specifically, the processing unit 7d executes predetermined processing designated by a user through the user interface unit 6 on contents data received by the communication unit 8, and changes the quality in processing of the contents data depending on the character information associated with the received contents data. The processing unit 7d updates the character information associated with the contents data, which is to be processed, depending on the run status of the processing executed on the contents data. Further, the processing unit 7d selects desired one of the contents data recorded in a contents data recording section 71 in response to a user's instruction entered from the user interface unit 6, and then transmits the selected contents data from the communication unit 8 to other contents data processing apparatuses or a contents data supply server.

In addition, the processing unit 7d also has a similar function to that of the processing unit 7a shown in FIG. 8. More specifically, when the contents data received by the communication unit 8 is charged data, the processing unit 7d limits the processing of the charged contents data. The limitation on the processing of the charged contents data is released upon predetermined payment information being inputted from the user interface unit 6. The payment condition in the step of checking the payment information is changed depending on the character information associated with the content data.

When the charged contents data is transmitted from the communication unit 8, the processing unit 7d executes a process of limiting the use of the charged contents data, e.g., an encrypting process, as required.

The processing unit 7d comprises, as shown in FIG. 14, a billing section 73a in addition to a contents data recording section 71, a contents data reproducing section 72, and a character information updating section 74.

The billing section 73a has the same function as the billing section 73, shown in FIG. 8, except for that the predetermined process of limiting the use of the charged contents data transmitted from the communication unit 8.

More specifically, the billing section 73a determines whether the contents data received by the communication unit 8 is charged data, and then displays the determination result on the user interface unit 6. When predetermined payment information corresponding to the display is inputted from the user interface unit 6, the billing section 73a checks whether the inputted payment information satisfies a predetermined payment condition. If the inputted payment information satisfies the predetermined payment condition, the billing section 73a releases the limitation on processing of the charged contents data so that the charged contents data can be processed in the contents data recording section 71 and the contents data reproducing section 72. If the inputted payment information does not satisfy the predetermined payment condition, the billing section 73a limits the processing of the charged contents data.

When the charged contents data is transmitted from the communication unit 8 to the other contents data processing apparatuses or the contents data supply server, the billing section 73a executes a process of limiting the use of the charged contents data, e.g., an encrypting process, as required.

The character information recorded in the contents data recording section 71 together with the contents data is updated in the character information updating section 74 depending on the run status of the processing executed on the contents data (such as the number of times of processing runs and the frequency of processing runs).

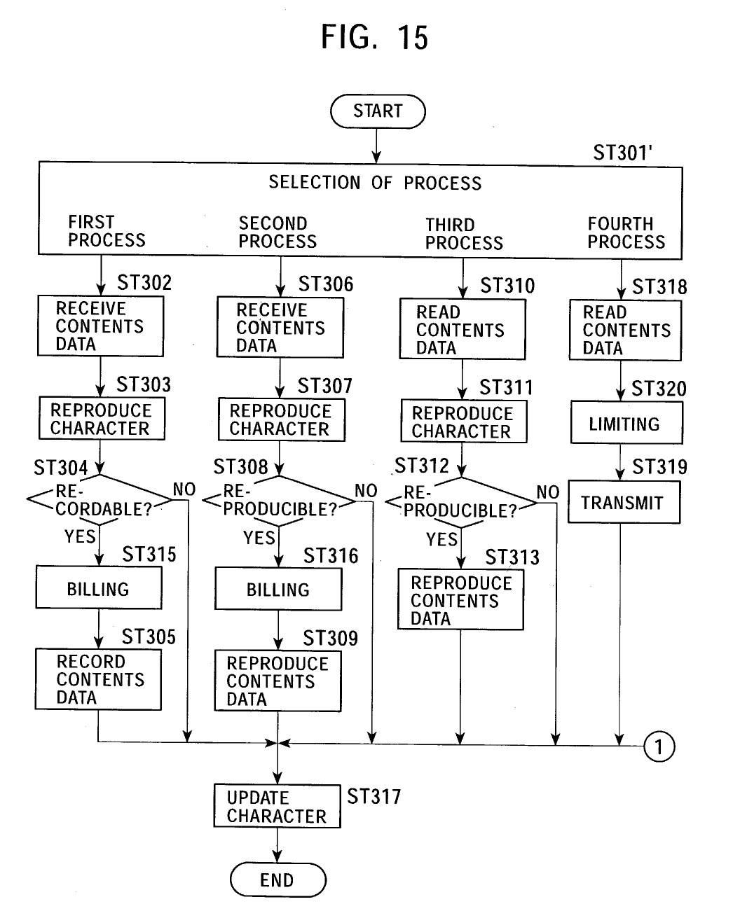

FIG. 15 is a flowchart for explaining one example of the contents data processing executed in the above-described contents data processing apparatus 101d of FIG. 14. In FIG. 15, the same symbols as those in FIG. 13 denote steps in each of which similar processing is executed as in FIG. 13.

As seen from comparing FIGS. 15 and 13, a flowchart of FIG. 15 differs from the flowchart of FIG. 13 in that billing processes (step ST315 and step ST316) are inserted respectively between steps ST304 and ST305 and between steps ST308 and ST309.

Each of those billing processes is substantially the same as the above-described process executed in accordance with the flowchart of FIG. 5 except for that the payment condition as a basis for checking the payment information in step ST204 is changed depending on the character information associated with the contents data.

The flowchart of FIG. 15 also differs from the flowchart of FIG. 13 in that a process of limiting the use of the contents data (step ST320) is inserted between a process of reading the contents data (step ST318) and a process of transmitting the contents data (step ST319) in a fourth process.

Stated otherwise, in the case of transmitting the contents data in the fourth process, the process of limiting the use of the contents data (e.g., encrypting process) is executed, as required, when the transmitted contents data is charged data.

Thus, the above-described contents data processing apparatus 101d of FIG. 14 can provide similar advantages as those in the contents data processing apparatus 101c of FIG. 12. In addition, since the payment condition in purchasing the charged contents data is changed depending on the character information, the fun in processing the contents data is further increased and users can feel even higher amusingness.

Note that the present invention is not limited to the first and second embodiment described above, but can be modified in various ways.

For example, a part or the whole of the configuration of the contents data processing apparatuses described above in the first and second embodiments, by way of example, can be realized using a processor, such as a computer, which executes processing in accordance with a program. The program may be stored in a storage device such as a hard disk and a semiconductor memory, or a storage medium such as a magnetic disk and a magneto-optical disk, and then read by the processor to execute the processing, as an occasion requires. The program may be stored in a server capable of communicating via a wired or wireless communication means, and then downloaded in the processor to execute the processing, as an occasion requires.

In the above-described second embodiment, the character information associated with the contents data may be only information indicating character properties, such as the nature and type of each character, or may contain image information and voice information reproducible in the character information reproducing section.

Stated otherwise, when image information and voice information are not contained in the character information, predetermined images and voices corresponding to the information indicating the character properties may be reproduced in the character information reproducing section. When image information and voice information are contained in the character information, those associated image information and voice information may be reproduced in the character information reproducing section.

While the above embodiments have been described in connection with the case in which the character information is stored beforehand, or the case in which the character information is inputted together with the contents data, the present invention is not limited to the above-described embodiments. Specific information for creating character information may be transmitted together with contents data, and the character information may be created using the specific information. Such a case will be described below in detail with reference to the drawings.

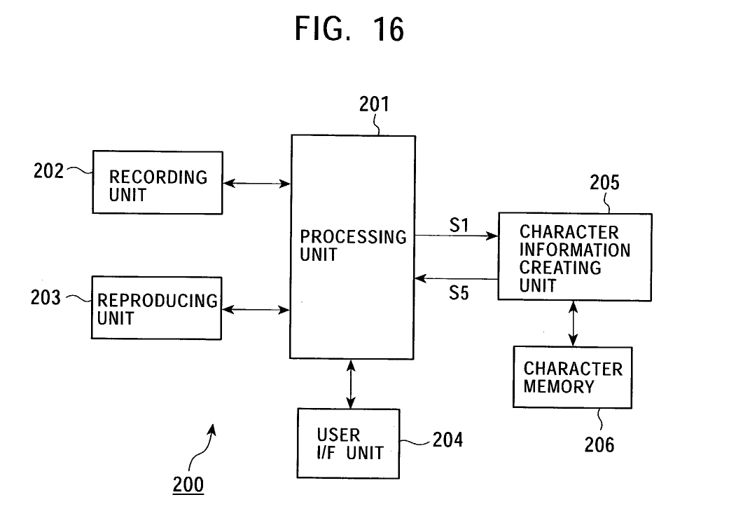

FIG. 16 is a schematic block diagram showing a configuration of a contents data processing apparatus according to a third embodiment of the present invention.

A contents data processing apparatus 200 shown in FIG. 16 comprises a processing unit 201, a recording unit 202, a reproducing unit 203, a user interface (I/F) unit 204, a character information creating unit 205, and a character memory 206.

The processing unit 201 executes a process of reproducing or recording contents data in response to a user's instruction entered from the user interface unit 204.

When the process of reproducing contents data is executed, the processing unit 201 reads contents data, which has been selected in response to the user's instruction, out of the contents data recorded in the recording unit 202, and then reproduces the read-out contents data depending in the reproducing unit 3. At this time, character information to be created corresponding to the read-out contents data is also reproduced in the character information creating unit 205 (described later in more detail) together with the read-out contents data.

For example, when the contents data and the character information are reproduced as images in the reproducing unit 203, the content and the character may be displayed on the same screen in a superimposed relation, or the character may be displayed to appear on the screen before or after reproduction of the content. When the reproducing unit 203 includes a plurality of displays, the content and the character may be displayed on respective different screens independently of each other.

When the process of recording contents data is executed, the processing unit 201 records character information, which has been created corresponding to the contents data, in the recording unit 202 in association with the contents data.

For example, the processing unit 201 may join the contents data and the character information into a single file and record the file in the recording unit 202, or may record the contents data and the character information in separate files.

The recording unit 202 records the contents data and the character information, which are supplied from the processing unit 201, under write control of the processing unit 201, and outputs the recorded contents data to the processing unit 201 under read control of the processing unit 201.

The recording unit 202 may be constituted using, for example, a stationary storage device such as a hard disk, or a combination of a removable storage medium such as a magneto-optical disk or a semiconductor memory card, a reader, and a write device.

The reproducing unit 203 reproduces the contents data and the character information under control of the processing unit 201.

The reproducing unit 203 includes, for example, a display for reproducing image information and a speaker for reproducing voice information, and reproduces images and voices corresponding to the contents data and the character information by those devices.

The user interface unit 204 includes input devices, such as a switch, a button, a mouse, a keyboard and a microphone, and transmits, to the processing unit 201, an instruction given from the user who performs a predetermined operation using those input devices. The user interface unit 204 may output the processing result of the processing unit 201 to the user using output devices such as a display, a lamp and a speaker.

The character information creating unit 205 creates character information depending on specific information associated with the contents data that is recorded or reproduced in the processing unit 201.

The character information created in the character information creating unit 205 contains information for reproducing images, voices, etc., of a virtual character corresponding to the content in the reproducing unit 203.

When the specific information associated with the contents data is information regarding the price of the relevant contents data, the character information may be created in the creating unit 205 depending on the price information.

For example, whether the price of the relevant contents data reaches a predetermined amount is determined based on the price information, and the character information depending on the determination result is created in the creating unit 205. As another example, when the price of the relevant contents data exceeds a certain level, the character information may be created so as to dress up clothing of the character.

The character information may be created in the creating unit 205 depending on information that is associated with the content data and indicates the type of the relevant content data.

For example, it is determined in accordance with the type information that the type of the relevant content data corresponds to which one of predetermined types, and the character information depending on the determination result is created in the creating unit 205.

To describe music content as an example, based on information of music genre associated with music content data (or other related information), it is determined that the genre of the music content corresponds to which one of predetermined genres (such as rock, jazz, Japanese popular songs, and classics). The character information depending on the determination result is then created in the creating unit 205. For example, when it is determined that the music content is a Japanese popular song, character information such as dressing a character in kimono (Japanese traditional clothe) is created in the creating unit 205.

The character information may be created depending on information that is associated with the content data and indicates the number of times at which the relevant content data has been copied in the past.

For example, whether the number of times of copying of the relevant content data reaches a predetermined value is determined in accordance with the information indicating the number of times of copying, and the character information depending on the determination result is created in the creating unit 205. When the number of times of copying exceeds the predetermined value, character information such as creating a character in twins may be created in the creating unit 205.

The character information may be newly created depending on the character information that is associated with the content data and has been created before.

For example, the character information is not changed regarding unchangeable attributes such as the price and the type, while the character information is changed depending on changeable attributes such as the number of times of copying or reproduction of the content data. The creating unit 205 may create character information such that information indicating the number of times of copying or reproduction of the contents data contained in the character information is updated each time the contents data is copied or reproduced, and the image and voice of a character is changed when the number of times of copying or reproduction reaches a predetermined value.

The character information created in the creating unit 205 may contain ID information for identifying the owner of a character. By associating the ID information with the contents data, the following advantage is obtained. When fraudulently copied contents data, for example, is found, it is possible to specify the owner of the character, for which fraudulent copying was made, by checking the ID information contained in the relevant character information.

When another person's ID information is contained in the character information associated with the contents data, the character information for the user may be created in the creating unit 205 depending on the character information for the other person.

For example, it is determined whether the ID information contained in the character information associated with the contents data is identical to the user's own ID information. If not identical, character information for the user is newly created depending on information regarding the type, nature, state, etc. of a character contained in the character information associated with the contents data. When the character for the other person is child, the character information may be created such that the character for the user is provided as a child of almost the same age.

When the character information containing another person's ID information includes a message issued from a character contained therein, the character information causing the character for the user to reply the message. For example, when the character for the other person issues a message “How many years old are you?”, the character information may be created such that the character for the user replies “I am five years old”.

The character information creating unit 205 has the functions described above.

The character memory 206 stores information necessary for a character to grow and change. The information stored in the character memory 206 is read and used, as required, when the character information is created in the character information creating unit 205. For example, the character memory 206 stores information necessary for reproducing character images and voices in the reproducing unit 3. In addition, the character memory 206 may also store the ID information for identifying the user of the contents data processing apparatus.

The character memory 206 may be constituted using, for example, a stationary storage device such as a hard disk, or a combination of a removable storage medium, such as a magneto-optical disk or a semiconductor memory card, and a reader.

The operation of the contents data processing apparatus 200 shown in FIG. 16 will be described below.

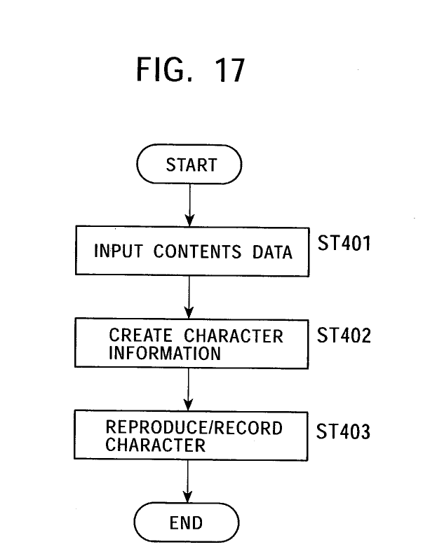

FIG. 17 is a flowchart for explaining one example of the contents data processing executed in the contents data processing apparatus 200 of FIG. 16.

Step ST401:

Contents data to be processed is inputted to the processing unit 201. In the example shown in FIG. 16, in response to a user's instruction entered from the user interface unit 204, the contents data instructed by the user to be processed is selected from among the contents data stored in the recording unit 202, and then read into the processing unit 201.

Step ST402:

Character information S5 is created depending on specific information Si associated with the inputted contents data.

More specifically, image and voice information of a character (e.g., information regarding the face, clothing and voice of a character, and messages) is read our of the character memory 206 and processed depending on information regarding the price, the type, the number of times of copying, the number of times of reproduction, etc. of the contents data, whereby the character information is created in the creating section 205.

When another person's ID information is contained in the character information, character information for the user is created in the creating unit 205 depending on the character information for the other person.

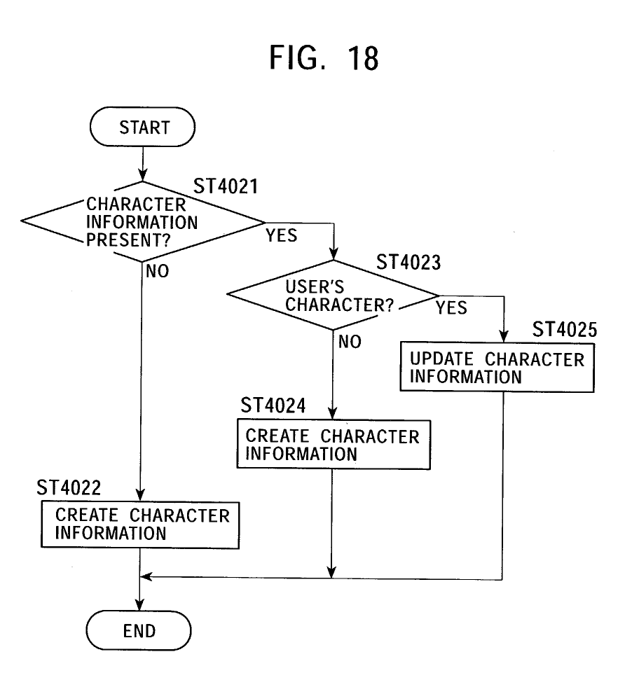

FIG. 18 is a flowchart for explaining one example of the more detailed process in the step ST402 of creating the character information.

According to the flowchart of FIG. 18, it is first determined whether the character information created before is associated with the inputted contents data (step ST4021). If it is determined in step ST4021 that the character information created before is not associated with the inputted contents data, new character information is created (step ST4022).

If it is determined in step ST4021 that the character information created before is associated with the inputted contents data, it is then determined whether the user's own ID information is contained in the character information created before (step ST4023). If it is determined that the another person's ID information is contained in the character information created before, character information for the user is newly created depending on information regarding the type, nature, state, etc. of a character contained in the character information for the other person (step ST4024).

If it is determined in step ST4023 that the user's own ID information is contained the character information associated with the inputted contents data, the character information is updated as required (step ST4025). The updating process in step ST4025 is executed, for example, by updating the character information when the number of times of copying or reproduction of the contents data reaches a predetermined value.

Step ST403

This step ST403 executes a process of recording or reproducing the inputted contents data and the character information created corresponding to the former.

More specifically, in the process of recording the contents data, the updated or newly created character information is recorded in the recording unit 202 in association with the contents data.

In the process of reproducing the contents data, the updated or newly created character information or the character information read out of the recording unit 202 in association with the contents data is reproduced together with the contents data.

With contents data processing apparatus 200 shown in FIG. 16, as described above, since a game factor of bringing up a character associated with the contents data is added to the ordinary fun in reproducing the contents data, users can feel higher amusingness with processing of the contents data.

The brought-up character is not a character associated with the contents data processing apparatus, but a character that moves and grows with the contents data. Therefore, each time different contents data is reproduced, users can be given with the opportunities of enjoying characters in different grown-up states. As a result, users can be more surely kept from becoming weary in bringing up characters in comparison with the case of bringing up only one character.

By containing the ID information of the character owner in the character information, it is possible to track down a user who has fraudulently copied the contents data.

When the character information for the user is newly created depending on the character information for another person, only the character for the user can be reproduced. By displaying the character for the user together with a character for the other person, however, the user can feed as if both the characters make communications with each other.

For example, when the character for the other person is a teacher type, the character for the user is set to a pupil type correspondingly and displayed together with the teacher type character.

As another example, when the character for the other person issues a message “How much is it?”, the character for the user is set to issue a message “You may have it for nothing” correspondingly and displayed together with the character for the other person.

Thus, since a user can make communications with another user, who records or reproduces contents data, via a virtual character reproduced in the reproducing unit 203, the user can be give with further increased amusingness.

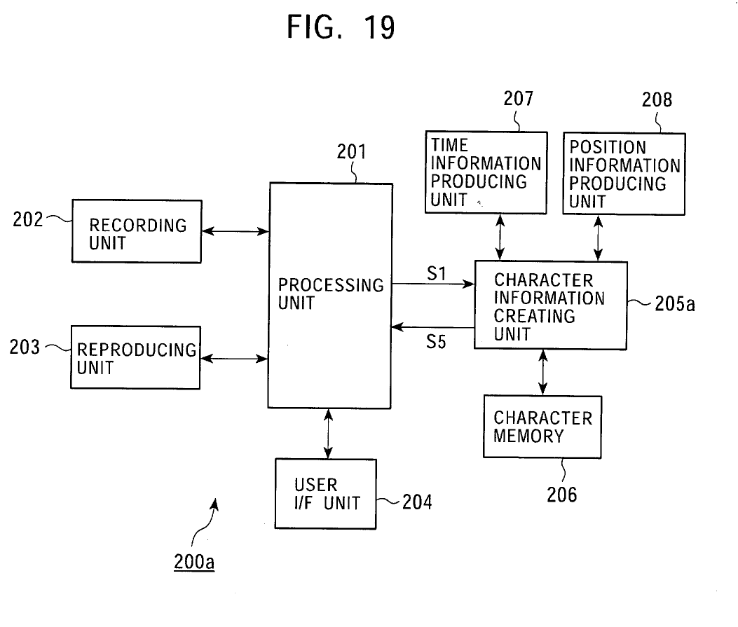

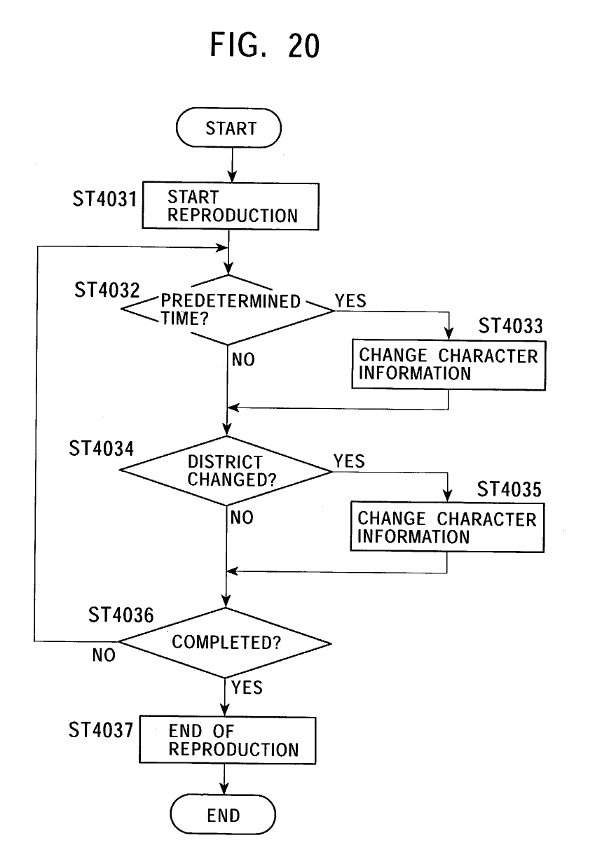

A configuration of a contents data processing apparatus according to a fourth embodiment of the present invention will be described below with reference to FIGS. 19 and 20.

In the fourth embodiment, character information is created depending on time information and/or position information.

FIG. 19 is a schematic block diagram showing the configuration of the contents data processing apparatus according to the fourth embodiment of the present invention.

A contents data processing apparatus 200a shown in FIG. 19 comprises a processing unit 201, a recording unit 202, a reproducing unit 203, a user interface (I/F) unit 204, a character information creating unit 205a, a character memory 206, a time information producing unit 207, and a position information producing unit 208. Note that the same components in FIG. 19 as those in FIG. 16 are denoted by the same symbols, and the above description should be referred to for details of those components.

The time information producing unit 207 produces time information, such as information regarding the time of day, information regarding time zones (forenoon, afternoon, etc.) per day, information regarding the day of week, information regarding the month, and information regarding the season.

The position information producing unit 208 produces information regarding the geographical position of the contents data processing apparatus 200a. For example, the producing unit 208 may produce position information by utilizing a mechanism of the GPS (Global Positioning System) for measuring the geographical position in accordance with a signal from a stationary satellite, etc.

The character information creating unit 205a has, in addition to the same function as that of the character information creating unit 205 shown in FIG. 16, the function of creating character information depending on the time information produced in the time information producing unit 207 and the position information produced in the position information producing unit 208.

For example, when the contents data is processed in the summer night, the creating unit 205a creates the character information dressing a character in a bath gown (informal kimono for summer wear).

When the contents data is processed in Hawaii, the creating unit 205a creates the character information dressing a character in an aloha shirt.

In the case of reproducing the contents data, the form of a character created in the creating unit 205a may be changed during the reproduction depending on the time information and/or the position information.

FIG. 20 is a flowchart for explaining one example of a process of reproducing contents data executed in the contents data processing apparatus 200a of FIG. 19. More specifically, FIG. 20 shows one example of the detailed process in step ST403 in the flowchart of FIG. 17.

According to the process of reproducing contents data shown in the flowchart of FIG. 20, after the start of reproduction of the contents data (step ST4031), it is determined whether the time of day indicated by the time information produced by the time information producing unit 207 reaches the predetermined time of day (step ST4032). If it is determined in step ST4032 that the indicated time of day reaches the predetermined time of day, the character information under the reproduction is changed depending on the predetermined time of day (step ST4033). For example, when the time of day at which the contents data is being reproduced reaches midnight 12:00, the clothing of the character is changed to pajamas.

Then, it is determined whether the district, in which the contents data processing apparatus 200a is located and which is indicated by the position information produced from the position information producing unit 208, has changed (step ST4034). If it is determined that the district where the contents data processing apparatus 200a is located has changed, the character information is also changed depending on the district to which the location of the contents data processing apparatus 200a has changed (step ST4035). For example, when it is determined that the contents data processing apparatus 200a which is reproducing contents data regarding professional baseball has moved from one to another district, the mark of a baseball cap put on the character is changed to the mark representing the professional baseball team in the district to which the contents data processing apparatus 200a has moved.

After the above-described determination regarding the time information (step ST4032) and the above-described determination regarding the district where the contents data processing apparatus 200a is located (step ST4034), it is determined whether the reproduction of the contents data is to be completed, and whether the end of reproduction of the contents data is instructed from the user interface unit 204 (step ST4036). If it is determined that the reproduction of the contents data is to be completed, or that the end of reproduction of the contents data is instructed, the process of reproducing the contents data is brought into an end (step ST4037). If it is determined in step ST4036 that the reproduction of the contents data is not to be completed and that the end of reproduction of the contents data is not instructed, i.e., that the reproduction of the contents data is to be continued, the process flow returns to step ST4032 to continue the process of reproducing the contents data.

Thus, the above-described contents data processing apparatus 200a of FIG. 19 can provide similar advantages as those in the contents data processing apparatus 200 of FIG. 16. In addition, since the character information can be changed depending on the time and location at and in which contents data is processed, it is possible to provide a variety variations in patterns for bringing up a character and to give users further increased amusingness.

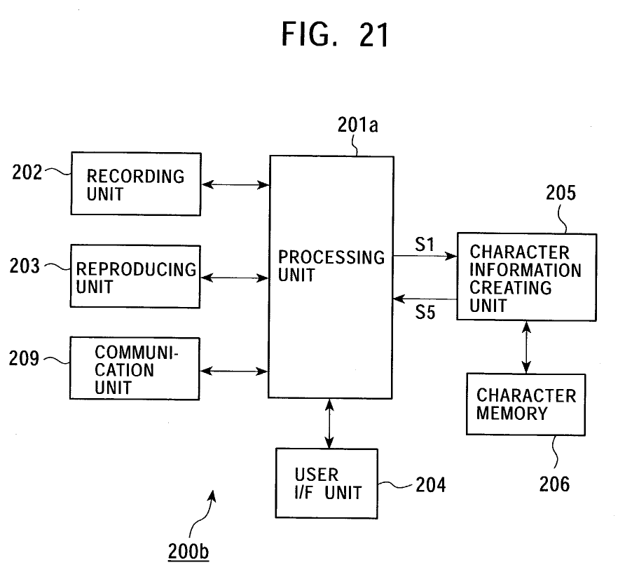

A fifth embodiment of a contents data processing apparatus will be described below with reference to FIG. 21.

FIG. 21 is a schematic block diagram showing a configuration of the contents data processing apparatus according to the fifth embodiment of the present invention.

A contents data processing apparatus 200b shown in FIG. 21 comprises a processing unit 201a, a recording unit 202, a reproducing unit 203, a user interface (I/F) unit 204, a character information creating unit 205, a character memory 206, and a communication unit 209. Note that components in FIG. 21 common to those in FIG. 16 are denoted by the same symbols, and a detailed description of those components is omitted here.

The communication unit 209 executes a process of exchanging contents data and character information with other contents data processing apparatuses or a contents data supply server for supplying contents data to those contents data processing apparatuses. Any suitable communication method can be employed in the communication unit 209. For example, wired or wireless communication is usable as required. Alternatively, the communication unit 209 may communicate via a network such as the Internet.

The processing unit 201a has, in addition to the same function as that of the processing unit 201 shown in FIG. 16, the function of selecting desired one of the contents data recorded in the recording unit 202 in response to a user's instruction entered from the user interface unit 204, and then transmitting the selected contents data from the communication unit 209 to other contents data processing apparatuses or a contents data supply server for supplying contents data to the other contents data processing apparatuses.

The communication unit 209 may be controlled to execute a process of accessing the other contents data processing apparatuses or the contents data supply server and then downloading the contents data held in them as contents data to be processed, and a process of, in response to a download request from the other contents data processing apparatuses or the contents data supply server, supplying the contents data recorded in the recording unit 202 to them.

Thus, the above-described contents data processing apparatus 200b of FIG. 21 can provide similar advantages as those in the contents data processing apparatus 200 of FIG. 16. In addition, since the contents data processing apparatus 200b can exchange or share contents data with the other contents data processing apparatuses or the contents data supply server. Therefore, since a user can bring up a character in cooperation with other users or exchange a character with other users, it is possible to give the user further increased amusingness.

Note that the present invention is not limited to the third to fifth embodiments described above, but can be modified in various ways.

For example, a part or the whole of the configuration of the contents data processing apparatuses described above in the third to fifth embodiments, by way of example, can be realized using a processor, such as a computer, which executes processing in accordance with a program. The program may be stored in a storage device such as a hard disk and a semiconductor memory, or a storage medium such as a magnetic disk and a magneto-optical disk, and then read by the processor to execute the processing, as an occasion requires. The program may be stored in a server capable of communicating via a wired or wireless communication means, and then downloaded in the processor to execute the processing, as an occasion requires.

The character information recorded in the recording unit 202 in association with the contents data may contain direct information used for reproducing a character (e.g., image information and voice information of a character), or may contain indirect information for designating the reproduced form of a character (e.g., information of numbers made correspondent respective patterns of a character) instead of containing the direct information. In the latter case, since the data amount of the character information is reduced in comparison with that of the character information containing image information and voice information, the required recording capacity of the recording unit 202 can be held down.

What is claimed is:

1. A contents data processing method comprising the steps of:
at the time of processing contents data, reproducing character information changed with processing of the contents data; and
selectively changing processing of the contents data in accordance with the reproduced character information.

2. A contents data processing method according to claim 1, further comprising a step of detecting whether the reproduced character information permits processing of the contents data, wherein the processing of the contents data is started when the reproduced character information permits the processing of the contents data.

3. A contents data processing method according to claim 2, wherein at the time of processing the contents data, processing quality is set in accordance with the character information.

4. A contents data processing method according to claim 3, wherein processing of supplemental data added to the contents data is set in accordance with the reproduced character information.

5. A contents data processing method according to claim 4, wherein quality in processing of the supplemental data added to the contents data is set in accordance with the reproduced character information.

6. A contents data processing method according to claim 4, wherein the processing of the supplemental data added to the contents data is prohibited in accordance with the reproduced character information.

7. A contents data processing method according to claim 2, further comprising a step of detecting whether the reproduced character information permits recording of the contents data, wherein the recording of the contents data is started when the reproduced character information permits the recording of the contents data.

8. A contents data processing method according to claim 7, wherein at the time of recording the contents data, recording quality is set in accordance with the character information.

9. A contents data processing method according to claim 7, further comprising a step of determining whether the contents data is charged data, when the reproduced character information permits processing of the contents data, wherein the processing of the contents data is limited when it is determined that the contents data is charged data.

10. A contents data processing method according to claim 9, further comprising steps of executing a billing process when it is determined that the contents data is charged data, and releasing limitations on the processing of the contents data when the billing process is properly executed.

11. A contents data processing method according to claim 10, wherein a condition of the billing process is changed in accordance with the character information.

12. A contents data processing method according to claim 10, wherein the limitations on the processing of the contents data is not released when the billing process is not properly executed.

13. A contents data processing method according to claim 2, further comprising a step of detecting whether the reproduced character information permits reproduction of the contents data, wherein the reproduction of the contents data is started when the reproduced character information permits the reproduction of the contents data.

14. A contents data processing method according to claim 13, wherein at the time of reproducing the contents data, reproduction quality is set in accordance with the character information.

15. A contents data processing method according to claim 13, further comprising a step of determining whether the contents data is charged data, when the reproduced character information permits processing of the contents data, wherein the processing of the contents data is limited when it is determined that the contents data is charged data.

16. A contents data processing method according to claim 15, further comprising steps of executing a billing process when it is determined that the contents data is charged data, and releasing limitations on the processing of the contents data when the billing process is properly executed.

17. A contents data processing method according to claim 16, wherein a condition of the billing process is changed in accordance with the character information.

18. A contents data processing method according to claim 16, wherein the limitations on the processing of the contents data is not released when the billing process is not properly executed.

19. A contents data processing method according to claim 2, further comprising a step of detecting whether the reproduced character information permits reproduction of the contents data, wherein contents data recorded in a recording unit is read out and processing of the read-out contents data is started when the reproduced character information permits the reproduction of the contents data.

20. A contents data processing method according to claim 19, wherein at the time of reproducing the contents data, reproduction quality is set in accordance with the character information.

21. A contents data processing method according to claim 1, further comprising steps of determining whether the contents data is charged data, when the reproduced character information permits processing of the contents data, and transmitting the contents data while limiting the processing of the contents data when it is determined that the contents data is charged data.

22. A contents data processing method according to claim 21, wherein the contents data is transmitted after encrypting the contents data when it is determined that the contents data is charged data.

23. A contents data processing method according to claim 1, wherein the character information is updated after the processing of the contents data is completed.

24. A contents data processing method according to claim 1, wherein the character information is stored in a character information storing unit beforehand and reproduced prior to the processing of the contents data.

25. A contents data processing method according to claim 1, wherein the character information is inputted together with the contents data and reproduced prior to the processing of the contents data.

26. A contents data processing method according to claim 1, wherein the character information contains information regarding images and voices of a virtual character.

27. A contents data processing method according to claim 1, wherein at the time of processing the contents data, the character information is created in accordance with at least one of information regarding time at which the contents data is processed and information regarding place where the contents data is processed.

28. A contents data processing method according to claim 1, wherein the character information is created in accordance with information regarding price of the contents data.

29. A contents data processing method according to claim 1, wherein the character information is created in accordance with information regarding type of the contents data.

30. A contents data processing method according to claim 1, wherein the character information is created in accordance with information regarding the number of times at which the contents data was copied in the past.

31. A contents data processing method according to claim 1, further comprising steps of determining whether character information created before is added to the contents data, and newly creating character information when any character information created before is not added to the contents data.

32. A contents data processing method according to claim 31, further comprising steps of determining, when character information created before is added to the contents data, whether user's own ID information is contained in the character information created before, and updating the character information in accordance with the processing of the contents data when the user's own ID information is contained.

33. A contents data processing method according to claim 32, wherein the contents data and the updated character information are stored.

34. A contents data processing method according to claim 31, wherein when ID information contained in the character information created before is another person's ID information, character information for a relevant user is created in accordance with the character information created before.

35. A contents data processing method according to claim 34, wherein the contents data and the created character information are stored.

36. A contents data processing apparatus comprising:
a storing unit for storing character information;
a reproducing unit for reproducing character information read out of said storing unit; and
a processing unit for processing supplied contents data, said processing unit selectively changing processing of the contents data in accordance with the character information reproduced by said reproducing unit.

37. A contents data processing apparatus according to claim 36, wherein said processing unit detects whether the reproduced character information permits processing of the contents data, and starts the processing of the contents data when the reproduced character information permits the processing of the contents data.

38. A contents data processing apparatus according to claim 37, wherein at the time of processing the contents data, said processing unit sets processing quality in accordance with the character information.

39. A contents data processing apparatus according to claim 38, wherein said processing unit sets processing of supplemental data added to the contents data in accordance with the reproduced character information.

40. A contents data processing apparatus according to claim 39, wherein said processing unit sets quality in processing of the supplemental data added to the contents data in accordance with the reproduced character information.

41. A contents data processing apparatus according to claim 39, wherein said processing unit prohibits the processing of the supplemental data added to the contents data in accordance with the reproduced character information.

42. A contents data processing apparatus according to claim 37, wherein said processing unit includes a recording section, and wherein said processing unit detects whether the reproduced character information permits recording of the contents data, and records the contents data by said recording section when the reproduced character information permits the recording of the contents data.

43. A contents data processing apparatus according to claim 42, wherein at the time of recording the contents data, said processing unit sets recording quality in accordance with the character information.

44. A contents data processing apparatus according to claim 42, wherein said processing unit further includes a billing section, and wherein said billing section determines whether the contents data is charged data, when the reproduced character information permits processing of the contents data, and limits the processing of the contents data when it is determined that the contents data is charged data.

45. A contents data processing apparatus according to claim 44, wherein said billing section executes a billing process when it is determined that the contents data is charged data, and releases limitations on the processing of the contents data when the billing process is properly executed.

46. A contents data processing apparatus according to claim 45, wherein a condition of the billing process is changed in accordance with the character information.

47. A contents data processing apparatus according to claim 45, wherein said billing section does not release the limitations on the processing of the contents data when the billing process is not properly executed.

48. A contents data processing apparatus according to claim 37, wherein said processing unit includes a reproducing section, and wherein said processing unit detects whether the reproduced character information permits reproduction of the contents data, and starts the reproduction of the contents data by said reproducing section when the reproduced character information permits the reproduction of the contents data.

49. A contents data processing apparatus according to claim 48, wherein at the time of reproducing the contents data, said processing unit sets reproduction quality in accordance with the character information.

50. A contents data processing apparatus according to claim 48, wherein said processing unit further includes a billing section, and wherein said billing section determines whether the contents data is charged data, when the reproduced character information permits processing of the contents data, and limits the processing of the contents data when it is determined that the contents data is charged data.

51. A contents data processing apparatus according to claim 50, wherein said billing section executes a billing process when it is determined that the contents data is charged data, and releases limitations on the processing of the contents data when the billing process is properly executed.

52. A contents data processing apparatus according to claim 51, wherein a condition of the billing process is changed in accordance with the character information.

53. A contents data processing apparatus according to claim 51, wherein said billing section does not release the limitations on the processing of the contents data when the billing process is not properly executed.

54. A contents data processing apparatus according to claim 37, wherein said processing unit includes a recording section for recording the contents data and a reproducing section for reproducing the contents data recorded in said recording section, and wherein said processing unit detects whether the reproduced character information permits reproduction of the contents data, and reads out the contents data recorded in said recording unit and reproduces the read-out contents data by said reproducing section when the reproduced character information permits the reproduction of the contents data.

55. A contents data processing apparatus according to claim 54, wherein at the time of reproducing the contents data, said processing unit sets reproduction quality in accordance with the character information.

56. A contents data processing apparatus comprising:
a reproducing unit for reproducing character information associated with supplied storing unit; and
a processing unit for processing the supplied contents data, said processing unit selectively changing processing of the contents data in accordance with the character information reproduced by said reproducing unit.

57. A contents data processing apparatus according to claim 56, wherein said processing unit detects whether the reproduced character information permits processing of the contents data, and starts the processing of the contents data when the reproduced character information permits the processing of the contents data.

58. A contents data processing apparatus according to claim 57, wherein at the time of processing the contents data, said processing unit sets processing quality in accordance with the character information.

59. A contents data processing apparatus according to claim 58, wherein said processing unit sets processing of supplemental data added to the contents data in accordance with the reproduced character information.

60. A contents data processing apparatus according to claim 59, wherein said processing unit sets quality in processing of the supplemental data added to the contents data in accordance with the reproduced character information.

61. A contents data processing apparatus according to claim 59, wherein said processing unit prohibits the processing of the supplemental data added to the contents data in accordance with the reproduced character information.

62. A contents data processing apparatus according to claim 57, wherein said processing unit includes a recording section, and wherein said processing unit detects whether the reproduced character information permits recording of the contents data, and records the contents data by said recording section when the reproduced character information permits the recording of the contents data.

63. A contents data processing apparatus according to claim 62, wherein at the time of recording the contents data, said processing unit sets recording quality in accordance with the character information.

64. A contents data processing apparatus according to claim 62, wherein said processing unit further includes a billing section, and wherein said billing section determines whether the contents data is charged data, when the reproduced character information permits processing of the contents data, and limits the processing of the contents data when it is determined that the contents data is charged data.

65. A contents data processing apparatus according to claim 64, wherein said billing section executes a billing process when it is determined that the contents data is charged data, and releases limitations on the processing of the contents data when the billing process is properly executed.

66. A contents data processing apparatus according to claim 65, wherein a condition of the billing process is changed in accordance with the character information.

67. A contents data processing apparatus according to claim 65, wherein said billing section does not release the limitations on the processing of the contents data when the billing process is not properly executed.

68. A contents data processing apparatus according to claim 57, wherein said processing unit includes a reproducing section, and wherein said processing unit detects whether the reproduced character information permits reproduction of the contents data, and starts the reproduction of the contents data by said reproducing section when the reproduced character information permits the reproduction of the contents data.

69. A contents data processing apparatus according to claim 68, wherein at the time of reproducing the contents data, said processing unit sets reproduction quality in accordance with the character information.

70. A contents data processing apparatus according to claim 68, wherein said processing unit further includes a billing section, and wherein said billing section determines whether the contents data is charged data, when the reproduced character information permits processing of the contents data, and limits the processing of the contents data when it is determined that the contents data is charged data.

71. A contents data processing apparatus according to claim 70, wherein said billing section executes a billing process when it is determined that the contents data is charged data, and releases limitations on the processing of the contents data when the billing process is properly executed.

72. A contents data processing apparatus according to claim 71, wherein a condition of the billing process is changed in accordance with the character information.

73. A contents data processing apparatus according to claim 71, wherein said billing section does not release the limitations on the processing of the contents data when the billing process is not properly executed.

74. A contents data processing apparatus according to claim 57, wherein said processing unit includes a recording section for recording the contents data and a reproducing section for reproducing the contents data recorded in said recording section, and wherein said processing unit detects whether the reproduced character information permits reproduction of the contents data, and reads out the contents data recorded in said recording unit and reproduces the read-out contents data by said reproducing section when the reproduced character information permits the reproduction of the contents data.

75. A contents data processing apparatus according to claim 74, wherein at the time of reproducing the contents data, said processing unit sets reproduction quality in accordance with the character information.

76. A contents data processing apparatus according to claim 56, wherein said processing unit determines whether the contents data is charged data, when the reproduced character information permits processing of the contents data, and transmits the contents data while limiting the processing of the contents data when it is determined that the contents data is charged data.

77. A contents data processing apparatus according to claim 76, wherein said processing unit transmits the contents data after encrypting the contents data when it is determined that the contents data is charged data.

78. A contents data processing apparatus according to claim 56, wherein said processing unit further includes a character updating section for updating the character information after the processing of the contents data is completed.

79. A contents data processing apparatus comprising:
a creating unit for creating character information from information associated with supplied contents data; and
a processing unit for processing the supplied contents data, said processing unit selectively changing processing of the contents data in accordance with the character information created by said creating unit.

80. A contents data processing apparatus according to claim 79, wherein at the time of processing the contents data, said creating unit creates the character information in accordance with at least one of information regarding time at which the contents data is processed and information regarding place where the contents data is processed.

81. A contents data processing apparatus according to claim 80, further comprising a time information producing unit for producing the information regarding time.

82. A contents data processing apparatus according to claim 80, further comprising a position information producing unit for producing the information regarding place.

83. A contents data processing apparatus according to claim 79, wherein said creating unit creates the character information in accordance with information regarding price of the contents data.

84. A contents data processing apparatus according to claim 79, wherein said creating unit creates the character information in accordance with information regarding type of the contents data.

85. A contents data processing apparatus according to claim 79, wherein said creating unit creates the character information in accordance with information regarding the number of times at which the contents data was copied in the past.

86. A contents data processing apparatus according to claim 79, wherein said processing unit determines whether character information created before is added to the contents data, and newly creates character information when any character information created before is not added to the contents data.

87. A contents data processing apparatus according to claim 86, wherein said processing unit determines, when character information created before is added to the contents data, whether user's own ID information is contained in the character information created before, and updates the character information in accordance with the processing of the contents data when the user's own ID information is contained.

88. A contents data processing apparatus according to claim 86, wherein when ID information contained in the character information created before is another person's ID information, said processing unit creates character information for a relevant user in accordance with the character information created before.
